(19) United States
(12) Patent Application Publication
(10) Pub. No.: US 2026/0317666 A1
(43) Pub. Date: Oct. 15, 2026

(54) BEER-FLAVORED BEVERAGE

(71) Applicant: SUNTORY HOLDINGS LIMITED, Osaka-shi, Osaka (JP)

(72) Inventors: Yuto Hata, Mishima-gun (JP); Yuichi Kato, Fuchu-shi (JP)

(73) Assignee: SUNTORY HOLDINGS LIMITED, Osaka-shi, Osaka (JP)

(21) Appl. No.: 19/491,538

(22) PCT Filed: Jun. 12, 2024
(86) PCT No.: PCT/JP2024/021288

§ 371 Date: Dec. 9, 2025

(30) Foreign Application Priority Data
Jun. 12, 2023 (JP) 2023-096514

(51) Int. Cl. C12C 5/02; C12C 11/00

(52) U.S. Cl. CPC C12C 5/02; C12C 11/003

(57) ABSTRACT

The beer-flavored beverage has an alcohol by volume of 5.0 (v/v) % or less, an apparent fermentation degree of 80% or less, an isomaltotriose content of 0.020 g/100 mL or more, and a pH of at least 4.30. The method for producing the beer-flavored beverage includes the following steps: step (1): a step of producing a pre-fermentation liquid by conducting, using various ingredients, at least one treatment selected from saccharification treatment, boiling treatment, and solids content removal treatment; step (2): a step of conducting alcoholic fermentation by adding yeast to the pre-fermentation liquid; and step (I): a step of adjusting or confirming the isomaltotriose content.

### TECHNICAL FIELD

The present invention relates to a beer-flavored beverage, a method for producing a beer-flavored beverage, and a method for improving a flavor of a beer-flavored beverage.

### BACKGROUND ART

In the related art, various beer-flavored beverages have been developed and distributed to the market in response to recent diversified preferences of consumers.

For example, Patent Document 1 discloses a beer-flavored beverage containing a predetermined amount of a cyclic dipeptide and having a pH adjusted to a predetermined range, for the purpose of providing a beer-flavored beverage having a flavor like beer.

### CITATION LIST

### Patent Document

Patent Document 1: WO 2017/115438

### SUMMARY OF INVENTION

### Technical Problem

Under such circumstances, there is a demand for a beer-flavored beverage in which a watery taste unsuitable for a beer-flavored beverage is suppressed even though the beer-flavored beverage is a low-alcohol beverage, the beer-flavored beverage being excellent in balance of taste thickness and aftertaste suitable for a beer-flavored beverage.

### Solution to Problem

An aspect of the present invention provides a beer-flavored beverage having an alcohol by volume of a predetermined value or less and having an apparent fermentation degree, an isomaltotriose content, and a pH adjusted to predetermined ranges.

As specific aspects, the following aspects [1] to are provided.

[1]

A beer-flavored beverage having:
an alcohol by volume of 5.0 (v/v) % or less;
an apparent fermentation degree of 80% or less;
an isomaltotriose content of 0.020 g/100 mL or more; and
a pH of 4.30 or more.
   [2]

The beer-flavored beverage according to [1], wherein a value P calculated from Formula (I) set forth below is 0.025 or more.

P=isomaltotriose content (unit: g/100 mL)/apparent fermentation degree (unit: %)×100 Formula (I):

[3]

The beer-flavored beverage according to [1] or [2], wherein a total content of acids consisting of phosphoric acid, citric acid, pyruvic acid, malic acid, succinic acid, lactic acid, formic acid, acetic acid, and pyroglutamic acid is 920 ppm by mass or more.

[4]

The beer-flavored beverage according to any one of [1] to [3], having a pyroglutamic acid content of 100 ppm by mass or more.

[5]

The beer-flavored beverage according to any one of [1] to [4], having a phosphoric acid content of 300 ppm by mass or more.

[6]

The beer-flavored beverage according to any one of [1] to [5], having a free amino nitrogen (FAN) content of 6.0 mg/100 mL or more.

[7]

The beer-flavored beverage according to any one of [1] to [6], having a real extract concentration of from 0.01 to 6.0 g/100 mL.

[8]

The beer-flavored beverage according to any one of [1] to [7], wherein the alcohol by volume is 3.5 (v/v) % or less.

[9]

The beer-flavored beverage according to any one of [1] to [7], wherein the alcohol by volume is 3.0 (v/v) % or less.

[10]

The beer-flavored beverage according to any one of [1] to [9], wherein the alcohol by volume is 0.5 (v/v) % or more.

[11]

The beer-flavored beverage according to any one of [1] to [10], having a malt proportion of 50 mass % or more and 100 mass % or less.

[12]

The beer-flavored beverage according to any one of [1] to [11], wherein the beer-flavored beverage is beer.

[13]

The beer-flavored beverage according to any one of [1] to [12], wherein the pH is 4.30 or more and 4.90 or less.

[14]

A method for producing a beer-flavored beverage having an alcohol by volume of 5.0 (v/v) % or less, an apparent fermentation degree of 80% or less, an isomaltotriose content of 0.020 g/100 mL or more, and a pH of 4.30 or more, the method including steps (1) to (2) set forth below and step (I) set forth below:
step (1): a step of producing a pre-fermentation liquid by conducting, using various ingredients, at least one treatment selected from saccharification treatment, boiling treatment, and solids content removal treatment;
step (2): a step of conducting alcoholic fermentation by adding yeast to the pre-fermentation liquid; and
step (I): a step of adjusting or confirming the isomaltotriose content.

A method for improving an aftertaste suitable for a beer-flavored beverage, the beer-flavored beverage having an alcohol by volume of 5.0 (v/v) % or less, the method comprising adding isomaltotriose.

A method for suppressing a watery taste unsuitable for a beer-flavored beverage, the beer-flavored beverage having an alcohol by volume of 5.0 (v/v) % or less, the method including adjusting a total content of acids consisting of phosphoric acid, citric acid, pyruvic acid, malic acid, succinic acid, lactic acid, formic acid, acetic acid, and pyroglutamic acid.

### Advantageous Effects of Invention

A beer-flavored beverage according to a preferred aspect of the present invention is a low-alcohol beverage in which a watery taste unsuitable for a beer-flavored beverage is suppressed, which can be a beverage excellent in a balance of taste thickness and aftertaste suitable for a beer-flavored beverage.

### DESCRIPTION OF EMBODIMENTS

For numerical ranges described in the present specification, any combination of upper and lower limits is possible. For example, a numerical range of “preferably from 30 to 100, more preferably from 40 to 80” also includes a range of “from 30 to 80” and a range of “from 40 to 100” in the numerical range described in the present specification. For example, the numerical range of “preferably 30 or more, and more preferably 40 or more, and preferably 100 or less, and more preferably 80 or less” also includes a range of “from 30 to 80” and a range of “from 40 to 100” in the numerical range described in the present specification.

As a numerical range described in the present specification, for example, a description of “from 60 to 100” means a range “60 or more (60 or more than 60) and 100 or less (100 or less than 100)”.

### 1. Beer-Flavored Beverage

In the present specification, the “beer-flavored beverage” refers to an alcohol-containing or non-alcoholic carbonated beverage with a beer-like flavor. That is, unless otherwise specified, the beer-flavored beverage in the present specification encompasses any carbonated beverage with a flavor of beer.

Thus, the “beer-flavored beverage” includes not only beer and fermented beer-flavored beverages, which are malt-fermented beverages produced by fermenting malt, hops, and water as ingredients with yeast, but also carbonated beverages (non-fermented beer-flavored beverages) to which a beer flavoring containing a flavor component such as an ester, a higher alcohol, lactone, or the like, is added.

Examples of the flavor component contained in the beer flavoring include isoamyl acetate, ethyl acetate, n-propanol, isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineole, 1,8-cineole, 2,3-diethyl-5-methylpyrazine, Y-decanolactone, γ-undecalactone, ethyl hexanoate, ethyl 2-methylbutyrate, ethyl n-butyrate, myrcene, limonene, maltol, ethyl maltol, phenylacetic acid, furaneol, furfural, methional, 3-methyl-2-butene-1-thiol, 3-methyl-2-butanethiol, diacetyl, ferulic acid, geranic acid, geranylacetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, ethyl 3-phenylpropionate, 2-ethyl-4-hydroxy-5-methyl-3(2H)-furanone, dimethylsulfone, 3-methylcyclopentane-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octen-3-ol, β-eudesmol, 4-mercapto-4-methylpentan-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-butene-1-one, trans-2-hexenal, nonanal, and phenethyl alcohol.

The beer-flavored beverage according to an aspect of the present invention may be a fermented beer-flavored beverage that has undergone a fermentation step using yeast or may be a non-fermented beer-flavored beverage that has not undergone a fermentation step.

The fermented beer-flavored beverage may be a top-fermented beer-flavored beverage (ale beer-flavored beverage) brewed through a fermentation step using a top-fermenting yeast (such as Saccharomyces), a bottom-fermented beer-flavored beverage (lager beer-flavored beverage, pilsner beer-flavored beverage) brewed through a fermentation step using a bottom-fermenting yeast (such as Saccharomyces), or a fermented beer-flavored beverage produced by using a top-fermenting yeast and a bottom-fermenting yeast at the same fermentation step or separate fermentation steps. The term “fermentation” in the present specification may be alcoholic fermentation that produces alcohol, or may be non-alcoholic fermentation that does not produce alcohol.

In addition, the beer-flavored beverage according to an aspect of the present invention may be a malt-containing beer-flavored beverage using malt as an ingredient, or may be a malt-free beer-flavored beverage not using malt. Examples of the malt-containing beer-flavored beverage include barley malt-containing beer-flavored beverages.

The beer-flavored beverage according to an aspect of the present invention may be an alcohol-containing beer-flavored beverage having an alcohol by volume of 1 (v/v) % or more, or may be a non-alcohol beer-flavored beverage having an alcohol by volume of less than 1 (v/v) %.

The non-alcohol beer-flavored beverage may be a non-alcohol fermented beer-flavored beverage produced by undergoing a fermentation step and then removing alcohol generated in the fermentation step, or may be a non-alcohol non-fermented beer-flavored beverage prepared to have a beer-like taste without undergoing a fermentation step. The non-alcohol beer-flavored beverage may be a non-alcohol beer-flavored beverage produced by a non-alcoholic fermentation step in which no alcohol is generated.

The alcohol by volume of the beer-flavored beverage according to an aspect of the present invention is adjusted to 5.0 (v/v) % or less. Thus, the beer-flavored beverage can be a low-alcohol beer-flavored beverage that is likely to cause moderate effect of drinking, and can be a beverage suitable for a consumer who has a feeling of resistance toward an alcoholic beverage.

From the aforementioned viewpoint, the alcohol by volume of the beer-flavored beverage according to an aspect of the present invention may be 4.9 (v/v) % or less, 4.8 (v/v) % or less, 4.7 (v/v) % or less, 4.6 (v/v) % or less, 4.5 (v/v) % or less, 4.4 (v/v) % or less, 4.3 (v/v) % or less, 4.2 (v/v) % or less, 4.1 (v/v) % or less, 4.0 (v/v) % or less, 3.9 (v/v) % or less, 3.8 (v/v) % or less, 3.7 (v/v) % or less, 3.6 (v/v) % or less, 3.5 (v/v) % or less, 3.4 (v/v) % or less, 3.3 (v/v) % or less, 3.2 (v/v) % or less, 3.1 (v/v) % or less, 3.0 (v/v) % or less, 2.9 (v/v) % or less, 2.8 (v/v) % or less, 2.7 (v/v) % or less, 2.6 (v/v) % or less, 2.5 (v/v) % or less, 2.4 (v/v) % or less, 2.3 (v/v) % or less, 2.2 (v/v) % or less, 2.1 (v/v) % or less, 2.0 (v/v) % or less, 1.8 (v/v) % or less, 1.6 (v/v) % or less, 1.5 (v/v) % or less, 1.4 (v/v) % or less, 1.3 (v/v) % or less, 1.2 (v/v) % or less, 1.1 (v/v) % or less, 1.0 (v/v) % or less, 0.9 (v/v) % or less, 0.8 (v/v) % or less, 0.7 (v/v) % or less, 0.6 (v/v) % or less, 0.5 (v/v) % or less, or less than 0.5 (v/v) %.

From the viewpoint of producing a low-alcohol beer-flavored beverage with further improved satisfying taste, the alcohol by volume of the beer-flavored beverage according to an aspect of the present invention may be 0.0 (v/v) % or more, more than 0.0 (v/v) %, 0.1 (v/v) % or more, 0.3 (v/v) % or more, 0.5 (v/v) % or more, 0.7 (v/v) % or more, 1.0 (v/v) % or more, 1.2 (v/v) % or more, 1.4 (v/v) % or more, 1.5 (v/v) % or more, 1.6 (v/v) % or more, 1.8 (v/v) % or more, 2.0 (v/v) % or more, 2.2 (v/v) % or more, 2.4 (v/v) % or more, 2.5 (v/v) % or more, 2.6 (v/v) % or more, 2.7 (v/v) % or more, 2.8 (v/v) % or more, 2.9 (v/v) % or more, 3.0 (v/v) % or more, 3.1 (v/v) % or more, 3.2 (v/v) % or more, 3.3 (v/v) % or more, or 3.4 (v/v) % or more.

In the present specification, the alcohol by volume is indicated as a percentage ((v/v) %) based on volume/volume. The alcohol by volume of a beverage can be measured by any known method and can be measured, for example, with a vibrating densimeter.

The alcohol by volume of the beer-flavored beverage according to an aspect of the present invention can be adjusted to a desired range by appropriately setting the addition of diluting water or carbonated water and the addition amount thereof when they are added, the types of ingredients (such as barley, malt, corn grits, and syrup), the amounts of ingredients, the type of enzyme, the amount of enzyme added, the timing of enzyme addition, the saccharification time in a preparation tank, the protein decomposition time in the preparation tank, the pH in the preparation tank, the pH in a preparation step (wort production step from feeding of malt until before addition of yeast), the amount of the acid to be added used in the pH adjustment, the timing of the pH adjustment (such as at the time of preparation, fermentation. or completion of fermentation, before beer filtration, and after beer filtration), the set temperature and retention time in each temperature region in preparation of wort (including during saccharification), the original extract concentration in a pre-fermentation liquid, the original extract concentration in the fermentation step, conditions of the fermentation step (such as the oxygen concentration, aeration conditions, yeast species, amount of yeast added, the number of yeast grown, the removal timing of yeast, fermentation temperature, fermentation time, pressure setting, and carbon dioxide concentration), presence or absence of addition of a spirit, a distilled alcohol or the like, the addition amount in the case of addition, and the like.

The beer-flavored beverage according to an aspect of the present invention may contain spirits (distilled liquor) derived from grains as an alcohol component to adjust the alcohol by volume to the range described above.

In the present specification, the “spirits” means an alcoholic beverage produced by saccharifying grain, such as barley and the like, rice, buckwheat, corn, potato, or sugar cane, as an ingredient using malt or, as necessary, an enzymatic agent, fermenting the saccharified product using yeast, and then distilling the fermented product. As the grain that is an ingredient of the spirits, a plant belonging to the family Gramineae is preferable, and barley and the like is more preferable.

The beer-flavored beverage according to an aspect of the present invention may be a beverage that does not contain spirits from the viewpoint of producing a beer-like low-alcohol beer-flavored beverage having a good flavor.

In the beer-flavored beverage according to an aspect of the present invention, the alcohol by volume is adjusted to 5.0 (v/v) % or less from the viewpoint of producing a low-alcohol beer-flavored beverage that is likely to cause moderate effect of drinking.

However, a beer-flavored beverage having a low alcohol by volume tends to have a watery taste unsuitable for a beer-flavored beverage, and also tends to have a decreased taste thickness and aftertaste suitable for a beer-flavored beverage.

In view of such a problem, the beer-flavored beverage according to an aspect of the present invention solves the problem by adjusting the apparent fermentation degree, the isomaltotriose content, and the pH to predetermined ranges with respect to a beer-flavored beverage having an alcohol by volume of 5.0 (v/v) % or less.

In the beer-flavored beverage according to an aspect of the present invention, the apparent fermentation degree is adjusted to 80% or less to obtain a beverage having an improved taste thickness suitable for a beer-flavored beverage even though the beer-flavored beverage is a low-alcohol beer-flavored beverage.

In the beer-flavored beverage according to an aspect of the present invention, from the viewpoint of obtaining a beverage with a further improved taste thickness suitable for a beer-flavored beverage even though the beer-flavored beverage is a low-alcohol beer-flavored beverage, the apparent fermentation degree is preferably 80% or less, 79% or less, 78% or less, 77% or less, 76% or less, 75% or less, 74% or less, 73% or less, 72% or less, 71% or less, 70% or less, 69% or less, 68% or less, 67% or less, 66% or less, 65% or less, 64% or less, 63% or less, 62% or less, 61% or less, 60% or less, 59% or less, 58% or less, 57% or less, 56% or less, 55% or less, or 54% or less, and it may be 30% or more, 32% or more, 35% or more, 37% or more, 40% or more, 41% or more, 42% or more, 43% or more, 44% or more, 45% or more, 46% or more, 47% or more, 48% or more, 49% or more, 50% or more, 51% or more, 52% or more, 53% or more, 54% or more, or 55% or more.

The beer-flavored beverage according to an aspect of the present invention also includes a non-fermented beer-flavored beverage having an apparent fermentation degree of 0% and a low-fermented beer-flavored beverage in which fermentation is terminated in the middle of a fermentation step having a low apparent fermentation degree (for example, 5% or less, 10% or less, 20% or less, 25% or less, 30% or less, 35% or less, or 40% or less).

The apparent fermentation degree can be adjusted by appropriately setting the addition of diluting water or carbonated water, the types of ingredients (such as malt, corn grits, and syrup), the amounts of ingredients, the type of enzyme, the amount of enzyme added (also including a saccharolytic enzyme or an isomerase), the temperature in enzymatic reaction, the timing of enzyme addition, the saccharification time, the pH during saccharification, the temperature during saccharification, the pH in the preparation step (wort production step from feeding of malt until before addition of yeast), the temperature in the preparation step, the time for wort filtration, the set temperature and retention time in each temperature region in preparation of wort (including during saccharification), the original extract concentration in the pre-fermentation liquid, the original extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, carbon dioxide concentration, amount of enzyme added, type of enzyme, and timing of enzyme addition), and the like.

In the present specification, the “apparent fermentation degree” means the proportion of the concentration of sugar that can be consumed by yeast as a nutrient source for alcoholic fermentation to the total concentration of sugar contained in the pre-fermentation liquid. For example, the apparent fermentation degree AA of a beer-flavored beverage can be calculated from Formula (1) set forth below.

AA(%)=100×(P−Es)/P Formula (1):

In Formula (1), “P” represents an original extract concentration (original wort extract concentration) and can be measured by a method described in “BCOJ Beer Analysis Method (published by The Brewing Society of Japan, edited by Brewers Association of Japan, revised: Nov. 1, 2004)”.

“Es” represents an apparent extract concentration of the beer-flavored beverage. The apparent extract concentration can be calculated from Formula (2) set forth below as described in, for example, “BCOJ Beer Analysis Method (published by The Brewing Society of Japan, edited by Brewers Association of Japan, revised: Nov. 1, 2004)”.

Es=−460.234+662.649×D−202.414×D2 Formula (2):

In Formula (2), D is the specific gravity of a degassed beer-flavored beverage.

The apparent extract concentration “Es” may have a negative value depending on D in Formula (2), and thus the calculated apparent fermentation degree may exceed 100%.

In the beer-flavored beverage according to an aspect of the present invention, the isomaltotriose content is adjusted to 0.020 g/100 mL or more to obtain a beverage having an improved aftertaste suitable for a beer-flavored beverage even though the beer-flavored beverage is a low-alcohol beer-flavored beverage.

In the beer-flavored beverage according to an aspect of the present invention, from the viewpoint of obtaining a beverage with a further improved aftertaste suitable for a beer-flavored beverage even though the beer-flavored beverage is a low-alcohol beer-flavored beverage, the isomaltotriose content is preferably 0.020 g/100 mL or more, 0.022 g/100 mL or more, 0.024 g/100 mL or more, 0.026 g/100 mL or more, 0.028 g/100 mL or more, 0.030 g/100 mL or more, 0.032 g/100 mL or more, 0.034 g/100 mL or more, 0.036 g/100 mL or more, 0.038 g/100 mL or more, 0.040 g/100 mL or more, 0.042 g/100 mL or more, 0.044 g/100 mL or more, 0.046 g/100 mL or more, 0.048 g/100 mL or more, 0.050 g/100 mL or more, 0.052 g/100 mL or more, 0.054 g/100 mL or more, 0.056 g/100 mL or more, 0.058 g/100 mL or more, 0.060 g/100 mL or more, 0.062 g/100 mL or more, 0.064 g/100 mL or more, 0.066 g/100 mL or more, 0.068 g/100 mL or more, 0.070 g/100 mL or more, 0.072 g/100 mL or more, 0.074 g/100 mL or more, 0.076 g/100 mL or more, 0.078 g/100 mL or more, 0.080 g/100 mL or more, or 0.082 g/100 mL or more, and it may be 10.00 g/100 mL or less, 9.50 g/100 mL or less, 9.00 g/100 mL or less, 8.50 g/100 mL or less, 8.00 g/100 mL or less, 7.50 g/100 mL or less, 7.00 g/100 mL or less, 6.50 g/100 mL or less, 6.00 g/100 mL or less, 5.50 g/100 mL or less, 5.00 g/100 mL or less, 4.50 g/100 mL or less, 4.00 g/100 mL or less, 3.50 g/100 mL or less, 3.00 g/100 mL or less, 2.50 g/100 mL or less, 2.00 g/100 mL or less, 1.90 g/100 mL or less, 1.80 g/100 mL or less, 1.70 g/100 mL or less, 1.60 g/100 mL or less, 1.50 g/100 mL or less, 1.40 g/100 mL or less, 1.30 g/100 mL or less, 1.20 g/100 mL or less, 1.10 g/100 mL or less, 1.00 g/100 mL or less, 0.900 g/100 mL or less, 0.800 g/100 mL or less, 0.700 g/100 mL or less, 0.600 g/100 mL or less, 0.500 g/100 mL or less, 0.400 g/100 mL or less, 0.300 g/100 mL or less, 0.200 g/100 mL or less, 0.190 g/100 mL or less, 0.180 g/100 mL or less, 0.170 g/100 mL or less, 0.160 g/100 mL or less, 0.150 g/100 mL or less, 0.140 g/100 mL or less, 0.130 g/100 mL or less, 0.120 g/100 mL or less, 0.110 g/100 mL or less, 0.100 g/100 mL or less, or 0.090 g/100 mL or less.

In the present specification, the isomaltotriose content can be measured by, for example, high performance liquid chromatography (HPLC).

The isomaltotriose content in the beer-flavored beverage according to an aspect of the present invention can be adjusted to a desired content by adjusting the amounts and proportions of sweeteners such as liquid sugar containing isomaltotriose and grains as ingredients, the type of enzyme (type of enzyme-containing ingredient and the like), the amount of enzymes added, the timing of enzyme addition, the set temperature and retention time in each temperature region in preparing the saccharified liquid, various conditions of the fermentation step (such as yeast species, amount of yeast added, the addition timing of yeast, the removal timing of yeast, the timing of reducing the yeast amount, the number of yeast grown, yeast growth time, yeast activity, the size of yeast (cell size), oxygen concentration, carbon dioxide concentration, nitrogen concentration, fermentation temperature, fermentation time, and pressure setting), and the like.

In addition, in the beer-flavored beverage according to an aspect of the present invention, to adjust the isomaltotriose content, an isomaltotriose purified product may be directly added, or the isomaltotriose content may be adjusted by appropriately setting the above-described conditions without substantially adding an isomaltotriose purified product.

The beer-flavored beverage according to an aspect of the present invention may contain isomaltose.

In the beer-flavored beverage according to an aspect of the present invention, the isomaltose content may be 0.001 g/100 mL or more, 0.005 g/100 mL or more, 0.010 g/100 mL or more, 0.015 g/100 mL or more, 0.020 g/100 mL or more, 0.025 g/100 mL or more, 0.030 g/100 mL or more, 0.035 g/100 mL or more, 0.040 g/100 mL or more, 0.045 g/100 mL or more, 0.050 g/100 mL or more, 0.060 g/100 mL or more, 0.070 g/100 mL or more, 0.080 g/100 mL or more, 0.090 g/100 mL or more, 0.100 g/100 mL or more, 0.120 g/100 mL or more, 0.140 g/100 mL or more, 0.150 g/100 mL or more, 0.160 g/100 mL or more, 0.180 g/100 mL or more, 0.200 g/100 mL or more, 0.220 g/100 mL or more, 0.240 g/100 mL or more, 0.250 g/100 mL or more, 0.260 g/100 mL or more, 0.280 g/100 mL or more, 0.300 g/100 mL or more, 0.320 g/100 mL or more, 0.340 g/100 mL or more, 0.350 g/100 mL or more, 0.360 g/100 mL or more, 0.380 g/100 mL or more, 0.400 g/100 mL or more, 0.420 g/100 mL or more, 0.440 g/100 mL or more, 0.450 g/100 mL or more, 0.460 g/100 mL or more, or 0.480 g/100 mL or more, and it may be 10.00 g/100 mL or less, 9.50 g/100 mL or less, 9.00 g/100 mL or less, 8.50 g/100 mL or less, 8.00 g/100 mL or less, 7.50 g/100 mL or less, 7.00 g/100 mL or less, 6.50 g/100 mL or less, 6.00 g/100 mL or less, 5.50 g/100 mL or less, 5.00 g/100 mL or less, 4.50 g/100 mL or less, 4.00 g/100 mL or less, 3.50 g/100 mL or less, 3.00 g/100 mL or less, 2.50 g/100 mL or less, 2.00 g/100 mL or less, 1.90 g/100 mL or less, 1.80 g/100 mL or less, 1.70 g/100 mL or less, 1.60 g/100 mL or less, 1.50 g/100 mL or less, 1.40 g/100 mL or less, 1.30 g/100 mL or less, 1.20 g/100 mL or less, 1.10 g/100 mL or less, 1.00 g/100 mL or less, 0.900 g/100 mL or less, 0.800 g/100 mL or less, 0.700 g/100 mL or less, 0.600 g/100 mL or less, 0.500 g/100 mL or less, 0.400 g/100 mL or less, 0.300 g/100 mL or less, 0.200 g/100 mL or less, 0.100 g/100 mL or less, or 0.090 g/100 mL or less.

In the beer-flavored beverage according to an aspect of the present invention, the total content of isomaltotriose and isomaltose may be 0.001 g/100 mL or more, 0.002 g/100 mL or more, 0.005 g/100 mL or more, 0.010 g/100 mL or more, 0.020 g/100 mL or more, 0.030 g/100 mL or more, 0.040 g/100 mL or more, 0.050 g/100 mL or more, 0.060 g/100 mL or more, 0.070 g/100 mL or more, 0.080 g/100 mL or more, 0.090 g/100 mL or more, 0.100 g/100 mL or more, 0.120 g/100 mL or more, 0.140 g/100 mL or more, 0.150 g/100 mL or more, 0.160 g/100 mL or more, 0.180 g/100 mL or more, 0.200 g/100 mL or more, 0.220 g/100 mL or more, 0.240 g/100 mL or more, 0.250 g/100 mL or more, 0.260 g/100 mL or more, 0.280 g/100 mL or more, 0.300 g/100 mL or more, 0.320 g/100 mL or more, 0.340 g/100 mL or more, 0.350 g/100 mL or more, 0.360 g/100 mL or more, 0.380 g/100 mL or more, 0.400 g/100 mL or more, 0.420 g/100 mL or more, 0.440 g/100 mL or more, 0.450 g/100 mL or more, 0.460 g/100 mL or more, 0.480 g/100 mL or more, or 0.500 g/100 mL or more, and it may be 20.00 g/100 mL or less, 18.00 g/100 mL or less, 16.00 g/100 mL or less, 15.00 g/100 mL or less, 14.00 g/100 mL or less, 12.00 g/100 mL or less, 10.00 g/100 mL or less, 9.00 g/100 mL or less, 8.00 g/100 mL or less, 7.00 g/100 mL or less, 6.00 g/100 mL or less, 5.50 g/100 mL or less, 5.00 g/100 mL or less, 4.50 g/100 mL or less, 4.00 g/100 mL or less, 3.50 g/100 mL or less, 3.00 g/100 mL or less, 2.50 g/100 mL or less, 2.00 g/100 mL or less, 1.90 g/100 mL or less, 1.80 g/100 mL or less, 1.70 g/100 mL or less, 1.60 g/100 mL or less, 1.50 g/100 mL or less, 1.40 g/100 mL or less, 1.30 g/100 mL or less, 1.20 g/100 mL or less, 1.10 g/100 mL or less, 1.00 g/100 mL or less, 0.900 g/100 mL or less, 0.800 g/100 mL or less, 0.700 g/100 mL or less, 0.600 g/100 mL or less, 0.500 g/100 mL or less, 0.400 g/100 mL or less, 0.300 g/100 mL or less, 0.200 g/100 mL or less, 0.100 g/100 mL or less, or 0.090 g/100 mL or less.

In the beer-flavored beverage according to an aspect of the present invention, the ratio [isomaltotriose/isomaltose] between the isomaltotriose content (unit: g/100 mL) and the isomaltose content (unit: g/100 mL) is preferably 0.010 or more, 0.015 or more, 0.020 or more, 0.025 or more, 0.030 or more, 0.035 or more, 0.040 or more, 0.045 or more, 0.050 or more, 0.055 or more, 0.060 or more, 0.065 or more, 0.070 or more, 0.075 or more, 0.080 or more, 0.085 or more, 0.090 or more, 0.100 or more, 0.110 or more, 0.120 or more, 0.130 or more, 0.140 or more, 0.150 or more, 0.160 or more, 0.170 or more, 0.180 or more, 0.190 or more, 0.200 or more, 0.210 or more, 0.220 or more, 0.230 or more, 0.240 or more, 0.250 or more, 0.260 or more, 0.270 or more, 0.280 or more, 0.290 or more, 0.300 or more, 0.400 or more, 0.500 or more, 0.600 or more, 0.700 or more, 0.800 or more, 0.900 or more, 1.00 or more, 1.10 or more, 1.20 or more, 1.30 or more, 1.40 or more, 1.50 or more, 1.60 or more, 1.70 or more, 1.80 or more, 1.90 or more, 2.00 or more, 2.20 or more, 2.40 or more, 2.60 or more, 2.80 or more, 3.00 or more, 3.20 or more, 3.40 or more, 3.50 or more, 3.60 or more, 3.80 or more, 4.00 or more, 4.20 or more, 4.30 or more, 4.40 or more, or 4.50 or more, from the viewpoint of obtaining a beverage having a further improved aftertaste suitable for a beer-flavored beverage, and it is preferably 10.0 or less, 9.50 or less, 9.00 or less, 8.50 or less, 8.00 or less, 7.50 or less, 7.00 or less, 6.50 or less, 6.00 or less, 5.50 or less, 5.00 or less, 4.80 or less, 4.60 or less, 4.40 or less, 4.20 or less, 4.00 or less, 3.80 or less, 3.60 or less, 3.40 or less, 3.20 or less, 3.00 or less, 2.80 or less, 2.60 or less, 2.40 or less, 2.20 or less, 2.00 or less, 1.80 or less, 1.60 or less, 1.40 or less, 1.20 or less, 1.10 or less, 1.00 or less, 0.950 or less, 0.900 or less, 0.850 or less, 0.800 or less, 0.750 or less, 0.700 or less, 0.650 or less, 0.600 or less, 0.550 or less, 0.500 or less, 0.450 or less, 0.400 or less, 0.350 or less, 0.300 or less, 0.250 or less, 0.200 or less, 0.190 or less, 0.180 or less, 0.170 or less, 0.160 or less, 0.150 or less, 0.140 or less, 0.130 or less, 0.120 or less, 0.110 or less, 0.100 or less, 0.090 or less, 0.080 or less, 0.070 or less, 0.060 or less, or 0.050 or less.

The beer-flavored beverage according to an aspect of the present invention may contain panose.

In the beer-flavored beverage according to an aspect of the present invention, the panose content may be 0.001 g/100 mL or more, 0.005 g/100 mL or more, 0.010 g/100 mL or more, 0.015 g/100 mL or more, 0.020 g/100 mL or more, 0.040 g/100 mL or more, 0.060 g/100 mL or more, 0.080 g/100 mL or more, 0.100 g/100 mL or more, 0.150 g/100 mL or more, 0.200 g/100 mL or more, 0.250 g/100 mL or more, 0.300 g/100 mL or more, 0.350 g/100 mL or more, 0.400 g/100 mL or more, 0.450 g/100 mL or more, 0.500 g/100 mL or more, 0.550 g/100 mL or more, 0.600 g/100 mL or more, 0.650 g/100 mL or more, 0.700 g/100 mL or more, 0.750 g/100 mL or more, 0.800 g/100 mL or more, 0.850 g/100 mL or more, 0.900 g/100 mL or more, 0.950 g/100 mL or more, 1.00 g/100 mL or more, 1.05 g/100 mL or more, 1.10 g/100 mL or more, 1.15 g/100 mL or more, 1.20 g/100 mL or more, 1.25 g/100 mL or more, 1.30 g/100 mL or more, 1.35 g/100 mL or more, 1.40 g/100 mL or more, 1.45 g/100 mL or more, 1.50 g/100 mL or more, or 1.55 g/100 mL or more, and it may be 10.00 g/100 mL or less, 9.50 g/100 mL or less, 9.00 g/100 mL or less, 8.50 g/100 mL or less, 8.00 g/100 mL or less, 7.50 g/100 mL or less, 7.00 g/100 mL or less, 6.50 g/100 mL or less, 6.00 g/100 mL or less, 5.50 g/100 mL or less, 5.00 g/100 mL or less, 4.50 g/100 mL or less, 4.00 g/100 mL or less, 3.50 g/100 mL or less, 3.00 g/100 mL or less, 2.50 g/100 mL or less, 2.00 g/100 mL or less, 1.90 g/100 mL or less, 1.80 g/100 mL or less, 1.70 g/100 mL or less, 1.60 g/100 mL or less, 1.50 g/100 mL or less, 1.40 g/100 mL or less, 1.30 g/100 mL or less, 1.20 g/100 mL or less, or 1.10 g/100 mL or less.

In the beer-flavored beverage according to an aspect of the present invention, the total content of isomaltotriose, isomaltose, and panose is 0.001 g/100 mL or more, 0.003 g/100 mL or more, 0.005 g/100 mL or more, 0.010 g/100 mL or more, 0.020 g/100 mL or more, 0.040 g/100 mL or more, 0.050 g/100 mL or more, 0.060 g/100 mL or more, 0.080 g/100 mL or more, 0.090 g/100 mL or more, 0.100 g/100 mL or more, 0.150 g/100 mL or more, 0.200 g/100 mL or more, 0.250 g/100 mL or more, 0.300 g/100 mL or more, 0.350 g/100 mL or more, 0.400 g/100 mL or more, 0.450 g/100 mL or more, 0.500 g/100 mL or more, 0.550 g/100 mL or more, 0.600 g/100 mL or more, 0.650 g/100 mL or more, 0.700 g/100 mL or more, 0.750 g/100 mL or more, 0.800 g/100 mL or more, 0.850 g/100 mL or more, 0.900 g/100 mL or more, 0.950 g/100 mL or more, 1.00 g/100 mL or more, 1.05 g/100 mL or more, 1.10 g/100 mL or more, 1.15 g/100 mL or more, 1.20 g/100 mL or more, 1.25 g/100 mL or more, 1.30 g/100 mL or more, 1.35 g/100 mL or more, 1.40 g/100 mL or more, 1.45 g/100 mL or more, 1.50 g/100 mL or more, 1.55 g/100 mL or more, 1.60 g/100 mL or more, 1.65 g/100 mL or more, or 1.70 g/100 mL or more, and it may be 30.00 g/100 mL or less, 25.00 g/100 mL or less, 20.00 g/100 mL or less, 15.00 g/100 mL or less, 14.00 g/100 mL or less, 12.00 g/100 mL or less, 10.00 g/100 mL or less, 9.00 g/100 mL or less, 8.00 g/100 mL or less, 7.00 g/100 mL or less, 6.00 g/100 mL or less, 5.50 g/100 mL or less, 5.00 g/100 mL or less, 4.50 g/100 mL or less, 4.00 g/100 mL or less, 3.50 g/100 mL or less, 3.00 g/100 mL or less, 2.90 g/100 mL or less, 2.80 g/100 mL or less, 2.70 g/100 mL or less, 2.60 g/100 mL or less, 2.50 g/100 mL or less, 2.40 g/100 mL or less, 2.30 g/100 mL or less, 2.20 g/100 mL or less, 2.10 g/100 mL or less, 2.00 g/100 mL or less, 1.90 g/100 mL or less, 1.80 g/100 mL or less, 1.75 g/100 mL or less, 1.70 g/100 mL or less, 1.65 g/100 mL or less, 1.60 g/100 mL or less, 1.55 g/100 mL or less, 1.50 g/100 mL or less, 1.45 g/100 mL or less, 1.40 g/100 mL or less, 1.35 g/100 mL or less, 1.30 g/100 mL or less, or 1.25 g/100 mL or less.

In the beer-flavored beverage according to an aspect of the present invention, the ratio [isomaltotriose/(isomaltotriose+isomaltose+panose)] of the isomaltotriose content (unit: g/100 mL) to the total content (unit: g/100 mL) of isomaltotriose, isomaltose, and panose is preferably 0.001 or more, 0.002 or more, 0.004 or more, 0.006 or more, 0.008 or more, 0.010 or more, 0.012 or more, 0.014 or more, 0.016 or more, 0.018 or more 0.020 or more, 0.022 or more, 0.024 or more, 0.026 or more, 0.028 or more, 0.030 or more, 0.031 or more, 0.032 or more, 0.033 or more, 0.034 or more, 0.035 or more, 0.036 or more, 0.037 or more, 0.038 or more, 0.039 or more, or 0.040 or more, from the viewpoint of obtaining a beverage with a further improved aftertaste suitable for a beer-flavored beverage, and it is preferably 1.00 or less, less than 1.00, 0.950 or less, 0.900 or less, 0.850 or less, 0.800 or less, 0.750 or less, 0.700 or less, 0.650 or less, 0.600 or less, 0.550 or less, 0.500 or less, 0.450 or less, 0.400 or less, 0.350 or less, 0.300 or less, 0.250 or less 0.200 or less, 0.190 or less, 0.180 or less, 0.170 or less, 0.160 or less, 0.150 or less, 0.140 or less, 0.130 or less, 0.120 or less, 0.110 or less, 0.100 or less, 0.095 or less, 0.090 or less, 0.085 or less, 0.080 or less, 0.075 or less, 0.070 or less, 0.068 or less, 0.066 or less, 0.064 or less, 0.062 or less, 0.060 or less, 0.058 or less, 0.056 or less, 0.054 or less, 0.052 or less, 0.050 or less, 0.048 or less, 0.046 or less, 0.044 or less, 0.042 or less, 0.040 or less, 0.039 or less, 0.038 or less, 0.037 or less, 0.036 or less, or 0.035 or less, from the viewpoint of obtaining a beverage with a further improved taste thickness suitable for a beer-flavored beverage.

In the present specification, the contents of isomaltose and panose can be measured by, for example, high performance liquid chromatography (HPLC).

The content of each of isomaltose and panose in the beer-flavored beverage according to an aspect of the present invention can be adjusted to desired contents by adjusting the amounts and proportions of sweeteners such as liquid sugar containing isomaltose and/or panose and grains as ingredients, the type of enzyme (type of enzyme-containing ingredient and the like), the amount of enzymes added, the timing of enzyme addition, the set temperature and retention time in each temperature region in preparing the saccharified liquid, various conditions of the fermentation step (such as yeast species, amount of yeast added, the addition timing of yeast, the removal timing of yeast, the timing of reducing the yeast amount, the number of yeast grown, yeast growth time, yeast activity, the size of yeast (cell size), oxygen concentration, carbon dioxide concentration, nitrogen concentration, fermentation temperature, fermentation time, and pressure setting), and the like.

In the beer-flavored beverage according to an aspect of the present invention, to adjust the isomaltose content, an isomaltose purified product may be directly added, or the isomaltose content may be adjusted by appropriately setting the above-described conditions without substantially adding an isomaltose purified product.

To adjust the panose content, a panose purified product may be directly added, or the panose content may be adjusted by appropriately setting the above-described conditions without substantially adding a panose purified product.

In the beer-flavored beverage according to an aspect of the present invention, the value P calculated from Formula (I) set forth below is preferably 0.025 or more from the viewpoint of obtaining a beverage excellent in balance of taste thickness and aftertaste suitable for a beer-flavored beverage even though the beer-flavored beverage is a low-alcohol beer-flavored beverage.

P=Isomaltotriose content (unit: g/100 mL)/apparent fermentation degree (%)×100 Formula (I):

From the aforementioned viewpoint, the value P calculated from Formula (I) is preferably 0.026 or more, 0.028 or more, 0.030 or more, 0.035 or more, 0.040 or more, 0.045 or more, 0.050 or more, 0.055 or more, 0.060 or more, 0.065 or more, 0.070 or more, 0.075 or more, 0.080 or more, 0.085 or more, 0.090 or more, 0.095 or more, 0.100 or more, 0.105 or more, 0.110 or more, 0.115 or more, 0.120 or more, 0.125 or more, 0.130 or more, 0.135 or more, 0.140 or more, 0.145 or more, 0.150 or more, 0.155 or more, or 0.160 or more, and it may be 1.000 or less, 0.950 or less, 0.900 or less, 0.850 or less, 0.800 or less, 0.750 or less, 0.700 or less, 0.650 or less, 0.600 or less, 0.550 or less, 0.500 or less, 0.450 or less, 0.400 or less, 0.350 or less, 0.300 or less, 0.290 or less, 0.280 or less, 0.270 or less, 0.260 or less, 0.250 or less, 0.240 or less, 0.230 or less, 0.220 or less, 0.210 or less, or 0.200 or less.

In the beer-flavored beverage according to an aspect of the present invention, even though the beer-flavored beverage is a low-alcohol beer-flavored beverage, the pH is adjusted to 4.30 or more to obtain a beverage in which a watery taste unsuitable for a beer-flavored beverage is suppressed.

The pH of the beer-flavored beverage according to an aspect of the present invention is preferably 4.30 or more, 4.32 or more, 4.34 or more, 4.36 or more, 4.38 or more, 4.40 or more, 4.42 or more, 4.44 or more, 4.46 or more, 4.48 or more, 4.50 or more, 4.52 or more, 4.54 or more, 4.56 or more, 4.58 or more, 4.60 or more, 4.62 or more, 4.64 or more, 4.66 or more, 4.68 or more, 4.70 or more, 4.72 or more, 4.74 or more, 4.76 or more, 4.78 or more, or 4.80 or more, and it may be 5.70 or less, 5.60 or less, 5.50 or less, 5.40 or less, 5.30 or less, 5.20 or less, 5.10 or less, 5.00 or less, 4.90 or less, 4.80 or less, 4.70 or less, or 4.60 or less, from the viewpoint of obtaining a beer-flavored beverage in which a watery taste unsuitable for a beer-flavored beverage is suppressed even though the beer-flavored beverage is a low-alcohol beer-flavored beverage.

In the beer-flavored beverage according to an aspect of the present invention, from the viewpoint of further suppressing a watery taste unsuitable for a beer-flavored beverage even though the beer-flavored beverage is a low-alcohol beer-flavored beverage and further improving the balance between the taste thickness and the aftertaste suitable for a beer-flavored beverage (in particular, from the viewpoint of obtaining a beverage in which a watery taste unsuitable for a beer-flavored beverage is further suppressed), the total content of acids consisting of phosphoric acid, citric acid, pyruvic acid, malic acid, succinic acid, lactic acid, formic acid, acetic acid, and pyroglutamic acid is preferably 920 ppm by mass or more, 930 ppm by mass or more, 940 ppm by mass or more, 950 ppm by mass or more, 960 ppm by mass or more, 970 ppm by mass or more, 980 ppm by mass or more, 990 ppm by mass or more, 1000 ppm by mass or more, 1010 ppm by mass or more, 1020 ppm by mass or more, 1030 ppm by mass or more, 1040 ppm by mass or more, 1050 ppm by mass or more, 1060 ppm by mass or more, 1070 ppm by mass or more, 1080 ppm by mass or more, 1090 ppm by mass or more, 1100 ppm by mass or more, 1110 ppm by mass or more, 1120 ppm by mass or more, 1130 ppm by mass or more, 1140 ppm by mass or more, 1150 ppm by mass or more, 1160 ppm by mass or more, 1170 ppm by mass or more, 1180 ppm by mass or more, 1190 ppm by mass or more, 1200 ppm by mass or more, 1210 ppm by mass or more, 1220 ppm by mass or more, 1230 ppm by mass or more, 1240 ppm by mass or more, 1250 ppm by mass or more, 1260 ppm by mass or more, 1270 ppm by mass or more, 1280 ppm by mass or more, 1290 ppm by mass or more, or 1300 ppm by mass or more, and it may be 3000 ppm by mass or less, 2900 ppm by mass or less, 2800 ppm by mass or less, 2700 ppm by mass or less, 2600 ppm by mass or less, 2500 ppm by mass or less, 2400 ppm by mass or less, 2300 ppm by mass or less, 2200 ppm by mass or less, 2100 ppm by mass or less, 2000 ppm by mass or less, 1950 ppm by mass or less, 1900 ppm by mass or less, 1850 ppm by mass or less, 1800 ppm by mass or less, 1750 ppm by mass or less, 1700 ppm by mass or less, 1650 ppm by mass or less, 1600 ppm by mass or less, 1550 ppm by mass or less, 1500 ppm by mass or less, 1450 ppm by mass or less, 1400 ppm by mass or less, 1350 ppm by mass or less, 1340 ppm by mass or less, 1330 ppm by mass or less, 1320 ppm by mass or less, 1310 ppm by mass or less, 1300 ppm by mass or less, 1290 ppm by mass or less, 1280 ppm by mass or less, 1270 ppm by mass or less, or 1260 ppm by mass or less.

In the beer-flavored beverage according to an aspect of the present invention, the phosphoric acid content is, from the above-described viewpoint, preferably 300 ppm by mass or more, 310 ppm by mass or more, 320 ppm by mass or more, 330 ppm by mass or more, 340 ppm by mass or more, 350 ppm by mass or more, 360 ppm by mass or more, 370 ppm by mass or more, 380 ppm by mass or more, 390 ppm by mass or more, 400 ppm by mass or more, 410 ppm by mass or more, 420 ppm by mass or more, 430 ppm by mass or more, 440 ppm by mass or more, or 450 ppm by mass or more, and it is preferably 700 ppm by mass or less, 650 ppm by mass or less, 600 ppm by mass or less, 590 ppm by mass or less, 580 ppm by mass or less, 570 ppm by mass or less, 560 ppm by mass or less, 550 ppm by mass or less, 540 ppm by mass or less, 530 ppm by mass or less, 520 ppm by mass or less, 510 ppm by mass or less, or 500 ppm by mass or less.

In the beer-flavored beverage according to an aspect of the present invention, the citric acid content is, from the above-described viewpoint, preferably 80 ppm by mass or more, 90 ppm by mass or more, 100 ppm by mass or more, 110 ppm by mass or more, 120 ppm by mass or more, 130 ppm by mass or more, 140 ppm by mass or more, 150 ppm by mass or more, 160 ppm by mass or more, 170 ppm by mass or more, 180 ppm by mass or more, 190 ppm by mass or more, 200 ppm by mass or more, or 210 ppm by mass or more, and it is preferably 400 ppm by mass or less, 380 ppm by mass or less, 360 ppm by mass or less, 340 ppm by mass or less, 320 ppm by mass or less, 300 ppm by mass or less, 290 ppm by mass or less, 280 ppm by mass or less, 270 ppm by mass or less, 260 ppm by mass or less, or 250 ppm by mass or less.

In the beer-flavored beverage according to an aspect of the present invention, the pyruvic acid content is, from the above-described viewpoint, preferably 1.0 ppm by mass or more, 3.0 ppm by mass or more, 5.0 ppm by mass or more, 7.0 ppm by mass or more, 10.0 ppm by mass or more, 15.0 ppm by mass or more, 20.0 ppm by mass or more, 25.0 ppm by mass or more, 30.0 ppm by mass or more, 35.0 ppm by mass or more, 40.0 ppm by mass or more, 50.0 ppm by mass or more, 60.0 ppm by mass or more, 70.0 ppm by mass or more, 80.0 ppm by mass or more, or 90.0 ppm by mass or more, and it is preferably 250 ppm by mass or less, 220 ppm by mass or less, 200 ppm by mass or less, 190 ppm by mass or less, 180 ppm by mass or less, 170 ppm by mass or less, 160 ppm by mass or less, 150 ppm by mass or less, 140 ppm by mass or less, 130 ppm by mass or less, 120 ppm by mass or less, 110 ppm by mass or less, or 100 ppm by mass or less.

In the beer-flavored beverage according to an aspect of the present invention, the malic acid content is, from the above-described viewpoint, preferably 40 ppm by mass or more, 45 ppm by mass or more, 50 ppm by mass or more, 55 ppm by mass or more, 60 ppm by mass or more, 65 ppm by mass or more, 70 ppm by mass or more, 75 ppm by mass or more, 80 ppm by mass or more, 85 ppm by mass or more, 90 ppm by mass or more, 95 ppm by mass or more, 100 ppm by mass or more, 105 ppm by mass or more, 110 ppm by mass or more, 115 ppm by mass or more, 120 ppm by mass or more, 125 ppm by mass or more, 130 ppm by mass or more, or 135 ppm by mass or more, and it is preferably 400 ppm by mass or less, 380 ppm by mass or less, 360 ppm by mass or less, 340 ppm by mass or less, 320 ppm by mass or less, 300 ppm by mass or less, 280 ppm by mass or less, 260 ppm by mass or less, 240 ppm by mass or less, 220 ppm by mass or less, 200 ppm by mass or less, 190 ppm by mass or less, 180 ppm by mass or less, 170 ppm by mass or less, 160 ppm by mass or less, or 150 ppm by mass or less.

In the beer-flavored beverage according to an aspect of the present invention, the succinic acid content is, from the above-described viewpoint, preferably 1.0 ppm by mass or more, 3.0 ppm by mass or more, 5.0 ppm by mass or more, 7.0 ppm by mass or more, 10.0 ppm by mass or more, 12.0 ppm by mass or more, 15.0 ppm by mass or more, 17.0 ppm by mass or more, 20.0 ppm by mass or more, 22.0 ppm by mass or more, 24.0 ppm by mass or more, 26.0 ppm by mass or more, 28.0 ppm by mass or more, 30.0 ppm by mass or more, 32.0 ppm by mass or more, 34.0 ppm by mass or more, 36.0 ppm by mass or more, 38.0 ppm by mass or more, 40.0 ppm by mass or more, 42.0 ppm by mass or more, 44.0 ppm by mass or more, 46.0 ppm by mass or more, 48.0 ppm by mass or more, or 50.0 ppm by mass or more, and it is preferably 250 ppm by mass or less, 220 ppm by mass or less, 200 ppm by mass or less, 180 ppm by mass or less, 160 ppm by mass or less, 150 ppm by mass or less, 140 ppm by mass or less, 130 ppm by mass ppm or less, 120 ppm by mass or less, 110 ppm by mass or less, 100 ppm by mass or less, 90 ppm by mass or less, 80 ppm by mass or less, 70 ppm by mass or less, or 60 ppm by mass or less.

In the beer-flavored beverage according to an aspect of the present invention, the lactic acid content is, from the above-described viewpoint, preferably 80 ppm by mass or more, 90 ppm by mass or more, 100 ppm by mass or more, 110 ppm by mass or more, 120 ppm by mass or more, 130 ppm by mass or more, 140 ppm by mass or more, 150 ppm by mass or more, 160 ppm by mass or more, 170 ppm by mass or more, 180 ppm by mass or more, 190 ppm by mass or more, 200 ppm by mass or more, or 210 ppm by mass or more, and it is preferably 400 ppm by mass or less, 380 ppm by mass or less, 360 ppm by mass or less, 340 ppm by mass or less, 320 ppm by mass or less, 300 ppm by mass or less, 290 ppm by mass or less, 280 ppm by mass or less, 270 ppm by mass or less, 260 ppm by mass or less, 250 ppm by mass or less, or 240 ppm by mass or less.

In the beer-flavored beverage according to an aspect of the present invention, the formic acid content is, from the above-described viewpoint, preferably 0.1 ppm by mass or more, 0.3 ppm by mass or more, 0.5 ppm by mass or more, 0.7 ppm by mass or more, 1.0 ppm by mass or more, 1.2 ppm by mass or more, 1.4 ppm by mass or more, 1.6 ppm by mass or more, 1.8 ppm by mass or more, 2.0 ppm by mass or more, 2.2 ppm by mass or more, 2.4 ppm by mass or more, 2.6 ppm by mass or more, 2.8 ppm by mass or more, 3.0 ppm by mass or more, 3.2 ppm by mass or more, 3.4 ppm by mass or more, 3.6 ppm by mass or more, 3.8 ppm by mass or more, or 4.0 ppm by mass or more, and it is preferably 70 ppm by mass or less, 60 ppm by mass or less, 50 ppm by mass or less, 40 ppm by mass or less, 30 ppm by mass or less, 20 ppm by mass or less, 18 ppm by mass or less, 16 ppm by mass or less, 14 ppm by mass or less, 12 ppm by mass or less, 10 ppm by mass or less, 9.0 ppm by mass or less, 8.0 ppm by mass or less, 7.0 ppm by mass or less, 6.0 ppm by mass or less, or 5.0 ppm by mass or less.

In the beer-flavored beverage according to an aspect of the present invention, the acetic acid content is, from the above-described viewpoint, preferably 1.0 ppm by mass or more, 3.0 ppm by mass or more, 5.0 ppm by mass or more, 7.0 ppm by mass or more, 10.0 ppm by mass or more, 12.0 ppm by mass or more, 15.0 ppm by mass or more, 17.0 ppm by mass or more, 20.0 ppm by mass or more, 25.0 ppm by mass or more, 30.0 ppm by mass or more, 35.0 ppm by mass or more, 40.0 ppm by mass or more, 45.0 ppm by mass or more, 50.0 ppm by mass or more, 55.0 ppm by mass or more, or 60.0 ppm by mass or more, and it is preferably 250 ppm by mass or less, 220 ppm by mass or less, 200 ppm by mass or less, 180 ppm by mass or less, 160 ppm by mass or less, 150 ppm by mass or less, 140 ppm by mass or less, 130 ppm by mass or less, 120 ppm by mass or less, 110 ppm by mass or less, 100 ppm by mass or less, 90 ppm by mass or less, or 80 ppm by mass or less.

In the beer-flavored beverage according to an aspect of the present invention, the pyroglutamic acid content is, from the above-described viewpoint, preferably 50 ppm by mass or more, 60 ppm by mass or more, 70 ppm by mass or more, 80 ppm by mass or more, 85 ppm by mass or more, 90 ppm by mass or more, 95 ppm by mass or more, 100 ppm by mass or more, 105 ppm by mass or more, 110 ppm by mass or more, 115 ppm by mass or more, 120 ppm by mass or more, 125 ppm by mass or more, 130 ppm by mass or more, 135 ppm by mass or more, or 140 ppm by mass or more, and it is preferably 400 ppm by mass or less, 380 ppm by mass or less, 360 ppm by mass or less, 340 ppm by mass or less, 320 ppm by mass or less, 300 ppm by mass or less, 280 ppm by mass or less, 260 ppm by mass or less, 240 ppm by mass or less, 220 ppm by mass or less, 200 ppm by mass or less, 190 ppm by mass or less, 180 ppm by mass or less, 170 ppm by mass or less, or 160 ppm by mass or less.

In the present specification, the content of each of phosphoric acid, citric acid, pyruvic acid, malic acid, succinic acid, lactic acid, formic acid, acetic acid, and pyroglutamic acid can be measured using an analyzer such as a high-performance liquid chromatography (HPLC) organic acid analysis system (apparatus name: Prominence, available from Shimadzu Corporation).

The content of each of phosphoric acid, citric acid, pyruvic acid, malic acid, succinic acid, lactic acid, formic acid, acetic acid, and pyroglutamic acid can be adjusted by appropriately setting the type and amount of malt used, and various conditions of the fermentation step (fermentation temperature, fermentation time, presence or absence of addition of enzyme, type of enzyme and timing of addition when enzyme is added, type of yeast and timing of addition). These acids may be appropriately added and adjusted, as necessary.

In the beer-flavored beverage according to an aspect of the present invention, it is preferable to contain at least one, two, three, four, five, six, seven, eight, or nine acid components selected from phosphoric acid, citric acid, pyruvic acid, malic acid, succinic acid, lactic acid, formic acid, acetic acid, and pyroglutamic acid.

In the beer-flavored beverage according to an aspect of the present invention, the free amino nitrogen (FAN) content may be, from the viewpoint of obtaining a beverage in which a watery taste unsuitable for a beer-flavored beverage is suppressed even though the beverage is a low-alcohol beer-flavored beverage and in which the balance of taste thickness and aftertaste suitable for a beer-flavored beverage is further improved (in particular, from the viewpoint of obtaining a beverage in which the balance between the taste thickness and the aftertaste suitable for a beer-flavored beverage is further improved), 6.0 mg/100 mL or more, 6.2 mg/100 mL or more, 6.4 mg/100 mL or more, 6.6 mg/100 mL or more, 6.8 mg/100 mL or more, 7.0 mg/100 mL or more, 7.2 mg/100 mL or more, 7.4 mg/100 mL or more, 7.6 mg/100 mL or more, 7.8 mg/100 mL or more, 8.0 mg/100 mL or more, 8.2 mg/100 mL or more, 8.4 mg/100 mL or more, 8.6 mg/100 mL or more, 8.8 mg/100 mL or more, 9.0 mg/100 mL or more, 9.2 mg/100 mL or more, 9.4 mg/100 mL or more, 9.6 mg/100 mL or more, 9.8 mg/100 mL or more, 10.0 mg/100 mL or more, 10.2 mg/100 mL or more, 10.4 mg/100 mL or more, 10.6 mg/100 mL or more, 10.8 mg/100 mL or more, 11.0 mg/100 mL or more, 11.2 mg/100 mL or more, 11.4 mg/100 mL or more, 11.6 mg/100 mL or more, 11.8 mg/100 mL or more, 12.0 mg/100 mL or more, 12.2 mg/100 mL or more, 12.4 mg/100 mL or more, 12.6 mg/100 mL or more, 12.8 mg/100 mL or more, or 13.0 mg/100 mL or more, and it may be 40.0 mg/100 mL or less, 35.0 mg/100 mL or less, 30.0 mg/100 mL or less, 29.0 mg/100 mL or less, 28.0 mg/100 mL or less, 27.0 mg/100 mL or less, 26.0 mg/100 mL or less, 25.0 mg/100 mL or less, 24.0 mg/100 mL or less, 23.0 mg/100 mL or less, 22.0 mg/100 mL or less, 21.0 mg/100 mL or less, 20.0 mg/100 mL or less, 19.0 mg/100 mL or less, 18.0 mg/100 mL or less, 17.0 mg/100 mL or less, 16.0 mg/100 mL or less, 15.0 mg/100 mL or less, 14.0 mg/100 mL or less, 13.0 mg/100 mL or less, 12.0 mg/100 mL or less, or 11.0 mg/100 mL or less.

In the present specification, the FAN content can be measured, for example, by a method described in 8.18 Free Amino Nitrogen of Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

The content of FAN can be adjusted by appropriately setting the addition of diluting water or carbonated water, the types of ingredients (such as malt, corn grits, and syrup), the amounts of ingredients, the type of enzyme, the amount of enzyme added (also including a proteolytic enzyme), the timing of enzyme addition, the time for proteolysis in a preparation tank, the pH in a preparation tank, the pH in the preparation step (wort production step from feeding of malt until before addition of yeast), the time for wort filtration, the set temperature and retention time in each temperature region in preparation of wort, the boiling time and pH in the boiling step, the original wort extract concentration in the pre-fermentation liquid, the original wort extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), and the like.

In the beer-flavored beverage according to an aspect of the present invention, the sugar content may be 0.5 g/100 mL or more, 0.6 g/100 mL or more, 0.7 g/100 mL or more, 0.8 g/100 mL or more, 0.9 g/100 mL or more, 1.0 g/100 mL or more, 1.1 g/100 mL or more, 1.2 g/100 mL or more, 1.3 g/100 mL or more, 1.4 g/100 mL or more, 1.5 g/100 mL or more, 1.6 g/100 mL or more, 1.7 g/100 mL or more, 1.8 g/100 mL or more, 1.9 g/100 mL or more, 2.0 g/100 mL or more, 2.1 g/100 mL or more, 2.2 g/100 mL or more, 2.3 g/100 mL or more, 2.4 g/100 mL or more, 2.5 g/100 mL or more, 2.6 g/100 mL or more, 2.7 g/100 mL or more, 2.8 g/100 mL or more, 2.9 g/100 mL or more, 3.0 g/100 mL or more, 3.1 g/100 mL or more, 3.2 g/100 mL or more, 3.3 g/100 mL or more, 3.4 g/100 mL or more, 3.5 g/100 mL or more, 3.6 g/100 mL or more, 3.7 g/100 mL or more, 3.8 g/100 mL or more, 3.9 g/100 mL or more, or 4.0 g/100 mL or more, and it may be 8.0 g/100 mL or less, 7.5 g/100 mL or less, 7.0 g/100 mL or less, 6.9 g/100 mL or less, 6.8 g/100 mL or less, 6.7 g/100 mL or less, 6.6 g/100 mL or less, 6.5 g/100 mL or less, 6.4 g/100 mL or less, 6.3 g/100 mL or less, 6.2 g/100 mL or less, 6.1 g/100 mL or less, 6.0 g/100 mL or less, 5.9 g/100 mL or less, 5.8 g/100 mL or less, 5.7 g/100 mL or less, 5.6 g/100 mL or less, 5.5 g/100 mL or less, 5.4 g/100 mL or less, 5.3 g/100 mL or less, 5.2 g/100 mL or less, 5.1 g/100 mL or less, 5.0 g/100 mL or less, 4.9 g/100 mL or less, 4.8 g/100 mL or less, 4.7 g/100 mL or less, 4.6 g/100 mL or less, 4.5 g/100 mL or less, 4.4 g/100 mL or less, 4.3 g/100 mL or less, 4.2 g/100 mL or less, 4.1 g/100 mL or less, 4.0 g/100 mL or less, 3.9 g/100 mL or less, 3.8 g/100 mL or less, 3.7 g/100 mL or less, 3.6 g/100 mL or less, 3.5 g/100 mL or less, 3.4 g/100 mL or less, 3.3 g/100 mL or less, 3.2 g/100 mL or less, 3.1 g/100 mL or less, or 3.0 g/100 mL or less.

The “sugar” in the present specification refers to a sugar based on the Nutrition Labeling Standards for Foods (Ministry of Health, Labour and Welfare Notification No. 176, 2003, Consumer Affairs Agency Notification No. 8, Partial Revision, Sep. 27, 2013) and specifically means a material in which protein, lipid, dietary fiber, ash, alcohol by volume, and water have been removed from the target food.

Thus, the sugar content in a food can be calculated by subtracting the amounts of protein, lipid, dietary fiber, ash, and water from the weight of the food.

Here, the amounts of protein, lipid, dietary fiber, ash, and water can be measured by the methods described in the Nutrition Labeling Standards. Specifically, the amount of protein can be measured by a method of quantitative conversion of nitrogen, the amount of lipid can be measured by an ether extraction method, the amount of dietary fiber can be measured by the Prosky method, the amount of ash can be measured by a direct ashing method, and the amount of water can be measured by a method of heating and drying under reduced pressure.

The sugar content can be adjusted by appropriately setting the addition of diluting water or carbonated water, the types of ingredients (such as malt, corn grits, and syrup), the amounts of ingredients, the type of enzyme, the amount of enzyme added (also including a saccharolytic enzyme or an isomerase), the timing of enzyme addition, the saccharification time, the pH during saccharification, the pH in the preparation step (wort production step from feeding of malt until before addition of yeast), the time for wort filtration, the set temperature and retention time in each temperature region in preparation of wort (including during saccharification), the original extract concentration in the pre-fermentation liquid, the original extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, carbon dioxide concentration, amount of enzyme added, type of enzyme, and addition timing of enzyme), and the like.

In the beer-flavored beverage according to an aspect of the present invention, the real extract concentration is preferably 0.10 g/100 mL or more, 0.20 g/100 mL or more, 0.30 g/100 mL or more, 0.40 g/100 mL or more, 0.50 g/100 mL or more, 0.60 g/100 mL or more, 0.70 g/100 mL or more, 0.80 g/100 mL or more, 0.90 g/100 mL or more, 1.00 g/100 mL or more, 1.10 g/100 mL or more, 1.20 g/100 mL or more, 1.30 g/100 mL or more, 1.40 g/100 mL or more, 1.50 g/100 mL or more, 1.60 g/100 mL or more, 1.70 g/100 mL or more, 1.80 g/100 mL or more, 1.90 g/100 mL or more, 2.00 g/100 mL or more, 2.10 g/100 mL or more, 2.20 g/100 mL or more, 2.30 g/100 mL or more, 2.40 g/100 mL or more, 2.50 g/100 mL or more, 2.60 g/100 mL or more, 2.70 g/100 mL or more, 2.80 g/100 mL or more, 2.90 g/100 mL or more, or 3.00 g/100 mL or more, from the viewpoint of obtaining a beer-flavored beverage having a further improved taste suitable for a beer-flavored beverage and a further improved satisfying taste, and it is preferably 6.00 g/100 mL or less, 5.90 g/100 mL or less, 5.80 g/100 mL or less, 5.70 g/100 mL or less, 5.60 g/100 mL or less, 5.50 g/100 mL or less, 5.40 g/100 mL or less, 5.30 g/100 mL or less, 5.20 g/100 mL or less, 5.10 g/100 mL or less, 5.00 g/100 mL or less, 4.90 g/100 mL or less, 4.80 g/100 mL or less, 4.70 g/100 mL or less, 4.60 g/100 mL or less, 4.50 g/100 mL or less, less than 4.50 g/100 mL, 4.40 g/100 mL or less, 4.30 g/100 mL or less, 4.20 g/100 mL or less, 4.10 g/100 mL or less, 4.00 g/100 mL or less, 3.90 g/100 mL or less, 3.80 g/100 mL or less, 3.70 g/100 mL or less, 3.60 g/100 mL or less, 3.50 g/100 mL or less, or 3.40 g/100 mL or less, from the viewpoint of obtaining a beer-flavored beverage excellent in clear finish.

In the present specification, the “real extract concentration” can be measured by the measurement method described in “8.4.3 Alcolyzer method” in Revised BCOJ Beer Analysis Method (published by Public Interest Incorporated Foundation, The Brewing Society of Japan, edited by Analysis Committee, Brewery Convention of Japan, Brewers Association of Japan, Enlarged and Revised Edition of 2013).

The real extract concentration can be adjusted by appropriately setting the addition of diluting water or carbonated water, the types of ingredients (such as malt, corn grits, and syrup), the pulverized grain size of malt, the pulverization mode of malt (such as wet pulverization and dry pulverization), the humidity at the time of pulverization of malt (extent of humidity adjustment), the temperature at the time of pulverization, the type of mill used at the time of pulverization, the amounts of ingredients, the type of enzyme, the amount of enzyme added, the timing of enzyme addition, the enzyme decomposition time, the saccharification time in a preparation tank, the time for proteolysis in the preparation tank, the pH in the preparation tank, the pH in a preparation step (wort production step from feeding of malt until before addition of yeast), the amount of the acid to be added used in the pH adjustment, the timing of the pH adjustment (such as at the time of preparation or fermentation), the set temperature and retention time in each temperature region in preparation of wort (including during saccharification), the wort filtration time, the temperature during the wort filtration, the pH during the wort filtration, the wort collection amount in the wort filtration, the amount of sparging water during the wort filtration, the pH of sparging water during the wort filtration, the temperature of sparging water during the wort filtration, the fermentation conditions (such as the oxygen concentration, aeration conditions, yeast species, amount of yeast added, the number of yeast grown, the removal timing of yeast, fermentation temperature, fermentation time, pressure setting, and carbon dioxide concentration), the addition of a spirit, a distilled alcohol or the like, and the like.

In the beer-flavored beverage according to an aspect of the present invention, the ethyl acetate content is, based on the total amount (100 mass %) of the beer-flavored beverage, preferably 5.0 ppm by mass or more, 5.2 ppm by mass or more, 5.4 ppm by mass or more, 5.6 ppm by mass or more, 5.8 ppm by mass or more, 6.0 ppm by mass or more, 6.2 ppm by mass or more, 6.4 ppm by mass or more, 6.6 ppm by mass or more, 6.8 ppm by mass or more, 7.0 ppm by mass or more, 7.2 ppm by mass or more, 7.4 ppm by mass or more, 7.6 ppm by mass or more, 7.8 ppm by mass or more, 8.0 ppm by mass or more, 8.2 ppm by mass or more, 8.4 ppm by mass or more, 8.6 ppm by mass or more, 8.8 ppm by mass or more, 9.0 ppm by mass or more, 9.2 ppm by mass or more, 9.4 ppm by mass or more, 9.6 ppm by mass or more, 9.8 ppm by mass or more, 10.0 ppm by mass or more, 10.2 ppm by mass or more, 10.4 ppm by mass or more, 10.6 ppm by mass or more, 10.8 ppm by mass or more, 11.0 ppm by mass or more, 11.2 ppm by mass or more, 11.4 ppm by mass or more, 11.6 ppm by mass or more, 11.8 ppm by mass or more, or 12.0 ppm by mass or more, from the viewpoint of imparting fruitiness or floral aroma as a beer-flavored beverage, and it may be 60.0 ppm by mass or less, 55.0 ppm by mass or less, 50.0 ppm by mass or less, 45.0 ppm by mass or less, 40.0 ppm by mass or less, 35.0 ppm by mass or less, 30.0 ppm by mass or less, 27.0 ppm by mass or less, 25.0 ppm by mass or less, 24.0 ppm by mass or less, 23.0 ppm by mass or less, 22.0 ppm by mass or less, 21.0 ppm by mass or less, 20.0 ppm by mass or less, 19.0 ppm by mass or less, 18.0 ppm by mass or less, 17.0 ppm by mass or less, 16.0 ppm by mass or less, or 15.0 ppm by mass or less, from the viewpoint of obtaining a beer-flavored beverage having a good flavor balance.

In the present specification, the ethyl acetate content can be measured by the measurement method described in “8.22 Low-boiling-point flavor component” in Revised BCOJ Beer Analysis Method (published by Public Interest Incorporated Foundation, The Brewing Society of Japan, edited by Analysis Committee, Brewery Convention of Japan, Brewers Association of Japan, Enlarged and Revised Edition of 2013).

The ethyl acetate content can be adjusted by appropriately setting, for example, the addition of diluting water or carbonated water, the addition of an ethyl acetate-containing flavoring, the amount of the ethyl acetate-containing flavoring, the amount of an ethyl acetate-containing ingredient, the addition of the ethyl acetate-containing ingredient, the types of ingredients containing ethyl acetate, the amount of the substrate of ethyl acetate, the amount of ingredients to be the substrate of ethyl acetate, the type of enzyme, the amount of enzyme added, the timing for enzyme addition, the saccharification time in a preparation tank, the proteolysis time in a preparation tank, the pH in a preparation tank, the pH in a preparation step (wort production step from feeding of malt until before addition of yeast), the amount of acid added for pH adjustment, timing for pH adjustment (during preparation, during fermentation, at completion of fermentation, before beer filtration, after beer filtration, or the like), the set temperature and retention time in each temperature region in preparation of wort (including during saccharification), the original extract concentration of a pre-fermentation liquid, the original extract concentration in a fermentation step, the fermentation conditions (such as the oxygen concentration, aeration conditions, yeast variety, amount of yeast added, the number of yeast grown, removal timing of yeast, fermentation temperature, fermentation time, pressure setting, carbon dioxide concentration), or the like.

In the beer-flavored beverage according to an aspect of the present invention, the bitterness value may be, from the viewpoint of obtaining a low-alcohol beer-flavored beverage having a moderate refreshing taste, 1.0 BUs or more, 2.0 BUs or more, 3.0 BUs or more, 4.0 BUs or more, 5.0 BUs or more, 6.0 BUs or more, 7.0 BUs or more, 8.0 BUs or more, 9.0 BUs or more, 10.0 BUs or more, 11.0 BUs or more, 12.0 BUs or more, 13.0 BUs or more, 14.0 BUs or more, 15.0 BUs or more, 16.0 BUs or more, 17.0 BUs or more, 18.0 BUs or more, 19.0 BUs or more, 20.0 BUs or more, 21.0 BUs or more, 22.0 BUs or more, 23.0 BUs or more, 24.0 BUs or more, 25.0 BUs or more, 26.0 BUs or more, 27.0 BUs or more, 28.0 BUs or more, 29.0 BUs or more, 30.0 BUs or more, 40.0 BUs or more, 50.0 BUs or more, 60.0 BUs or more, 70.0 BUs or more, 80.0 BUs or more, 90.0 BUs or more, or 100 BUs or more, and it may be 150 BUs or less, 120 BUs or less, 100 BUs or less, 90.0 BUs or less, 80.0 BUs or less, 70.0 BUs or less, 60.0 BUs or less, 50.0 BUs or less, 45.0 BUs or less, 40.0 BUs or less, 39.0 BUs or less, 38.0 BUs or less, 37.0 BUs or less, 36.0 BUs or less, or 35.0 BUs or less.

The beer-flavored beverage according to an aspect of the present invention may be a beverage substantially using no hops. The bitterness value in this aspect may be less than 1.0 BUs, less than 0.5 BUs, less than 0.1 BUs, or less than 0.01 BUs.

In the present specification, the “bitterness value” of the beverage can be measured by the measurement method described in “8.15 Bitterness Value” in Revised BCOJ Beer Analysis Method (published by Public Interest Incorporated Foundation, The Brewing Society of Japan, edited by Analysis Committee, Brewery Convention of Japan, Brewers Association of Japan, Enlarged and Revised Edition of 2013).

The bitterness value of the beer-flavored beverage according to an aspect of the present invention is an index of the bitterness imparted by a hop-derived component containing isohumulone as a main component, and can be controlled by, for example, appropriately adjusting the type, amount, and addition timing of hops.

In the beer-flavored beverage according to an aspect of the present invention, the total polyphenol amount is preferably 10 ppm by mass or more, 20 ppm by mass or more, 30 ppm by mass or more, 40 ppm by mass or more, 50 ppm by mass or more, 60 ppm by mass or more, or 70 ppm by mass or more, and it is preferably 500 ppm by mass or less, 400 ppm by mass or less, 350 ppm by mass or less, 300 ppm by mass or less, 250 ppm by mass or less, 200 ppm by mass or less, 180 ppm by mass or less, or 160 ppm by mass or less, from the viewpoint of obtaining a low-alcohol beer-flavored beverage in which an appropriate satisfying taste and a refreshing taste are improved in a well-balanced manner.

The “total polyphenol amount” in the present specification is the total amount of polyphenols contained in the total amount (100 mass %) of the beer-flavored beverage.

The polyphenol means a compound in which two or more hydrogens of an aromatic hydrocarbon are substituted with a hydroxyl group, and specific examples thereof include flavonol, isoflavone, tannin, catechin, quercetin, and anthocyanin.

In the present specification, the total polyphenol amount can be measured by a method described in Revised BCOJ Beer Analysis Method (published by Public Interest Incorporated Foundation, The Brewing Society of Japan, edited by Analysis Committee, Brewery Convention of Japan, Brewers Association of Japan, Enlarged and Revised Edition of 2013).

The total polyphenol amount can be controlled by adjusting the amount of use of an ingredient with a high polyphenol content, such as barley malt or malt husks (hulls).

In general, malt with husks (hulls) or the like has a high polyphenol content, and soybeans, yeast extract, wheat, wheat malt, and the like have a low polyphenol content. The polyphenol content can be adjusted to a desired range by appropriately selecting such an ingredient and adjusting the amount of use thereof.

In the beer-flavored beverage according to an aspect of the present invention, the wort extract (O-Ex) concentration may be 5.0 mass % or more, 5.5 mass % or more, 6.0 mass % or more, 6.5 mass % or more, 7.0 mass % or more, 7.5 mass % or more, 8.0 mass % or more, 8.5 mass % or more, 9.0 mass % or more, 9.5 mass % or more, or 10.0 mass % or more, and it may be 20.0 mass % or less, 18.0 mass % or less, 16.0 mass % or less, 15.0 mass % or less, or 13.5 mass % or less.

The “original wort extract concentration” in the present specification can be measured by the method described in “BCOJ Beer Analysis Method (published by The Brewing Society of Japan, edited by Brewers Association of Japan, revised edition of Nov. 1, 2004)”.

The malt proportion of the beer-flavored beverage according to an aspect of the present invention may be 5 mass % or more, 10 mass % or more, 15 mass % or more, 20 mass % or more, 25 mass % or more, 30 mass % or more, 35 mass % or more, 40 mass % or more, 45 mass % or more, 50 mass % or more, 55 mass % or more, 60 mass % or more, 65 mass % or more, 66 mass % or more, more than 66 mass %, 67 mass % or more, 70 mass % or more, 75 mass % or more, 80 mass % or more, 85 mass % or more, 90 mass % or more, 95 mass % or more, or 100 mass %, and it may be 100 mass % or less, less than 100 mass %, 98 mass % or less, 95 mass % or less, 90 mass % or less, 85 mass % or less, 80 mass % or less, 75 mass % or less, 70 mass % or less, 68 mass % or less, 67 mass % or less, or 66 mass % or less.

In the present specification, the “malt proportion” means a value calculated according to the Interpretation Notice on the Liquor Tax Law and the Administrative Ordinance Related to Alcoholic Beverages and the like enforced on Apr. 1, 2018.

In the case of suppressing the malt proportion, it is preferable to increase amounts of ingredients (carbon source and nitrogen source) other than malt that can be utilized by yeast. Examples of carbon sources as the ingredients which can be utilized by yeast include monosaccharides, disaccharides, trisaccharides, and syrups thereof; examples of nitrogen sources as the ingredients that can be utilized by yeast include yeast extracts, soybean proteins, malt, soybeans, peas, wheat malt, ungerminated cereal grains, and decomposition products thereof. Examples of the ungerminated grains include ungerminated barley, wheat, rye, common wild oat, oat, adlay, rice (such as white rice and brown rice), corn, kaoliang, potato, legumes (such as soybean and pea), buckwheat, sorghum, foxtail millet, and Japanese millet. In addition, starches collected from these grains and extracts thereof may be used.

The beer-flavored beverage according to an aspect of the present invention may be beer.

In the present specification, the “beer” means a beverage produced by using malt, hops, and water as ingredients and fermenting them with yeast, and specifically means one defined by the Interpretation Notice on the Liquor Tax Law and the Administrative Ordinance Related to Alcoholic Beverages and the like enforced on Apr. 1, 2018.

That is, when the beer-flavored beverage according to an aspect of the present invention is beer, the alcohol by volume is adjusted by the fermentation step using yeast.

The color of the beer-flavored beverage according to an aspect of the present invention is not particularly limited, and it may be amber or golden like ordinary beer, black like dark beer, or colorless and transparent, or may be colored as desired by adding a coloring agent or the like. The color of the beer-flavored beverage can be determined by the naked eye, but may be defined by the total light transmittance, chromaticity, or the like.

The chromaticity of the beer-flavored beverage according to an aspect of the present invention may be 0.1 EBC or more, more than 1.0 EBC, 1.5 EBC or more, 2.0 EBC or more, 2.5 EBC or more, 3.0 EBC or more, 3.5 EBC or more, 4.0 EBC or more, 4.5 EBC or more, 5.0 EBC or more, 6.0 EBC or more, 6.5 EBC or more, 7.0 EBC or more, 7.5 EBC or more, 8.0 EBC or more, 8.5 EBC or more, 9.0 EBC or more, 9.5 EBC or more, 10.0 EBC or more, 10.5 EBC or more, 11.0 EBC or more, 11.5 EBC or more, 12.0 EBC or more, 12.5 EBC or more, or 13.0 EBC or more, and it may be 500 EBC or less, 450 EBC or less, 400 EBC or less, 350 EBC or less, 300 EBC or less, 270 EBC or less, 250 EBC or less, 220 EBC or less, 200 EBC or less, 180 EBC or less, 160 EBC or less, 140 EBC or less, 120 EBC or less, 100 EBC or less, 80 EBC or less, 70 EBC or less, 60 EBC or less, 50 EBC or less, 40 EBC or less, 35 EBC or less, 30 EBC or less, 27 EBC or less, 25 EBC or less, 23 EBC or less, 20 EBC or less, 18 EBC or less, 16 EBC or less, or 15 EBC or less.

In the present specification, the “chromaticity” of the beer-flavored beverage can be measured by the measurement method described in “8.8 Chromaticity” in Revised BCOJ Beer Analysis Method (published by Public Interest Incorporated Foundation, The Brewing Society of Japan, edited by Analysis Committee, Brewery Convention of Japan, Brewers Association of Japan, Enlarged and Revised Edition of 2013). The “chromaticity” of the beer-flavored beverage is specified by the unit of chromaticity (EBC unit) defined by the European Brewery Convention. A beverage with a smaller numerical value has a lighter and brighter color. Conversely, a beverage with a larger numerical value has a deeper and darker color.

The chromaticity of the beer-flavored beverage can be controlled, for example, by appropriately adjusting the type of malt used, the blending proportion in a case of using two or more types of malts in combination, the boiling conditions for preparation of the pre-fermentation liquid, and the like. More specifically, for example, to increase the chromaticity of the beer-flavored beverage, the chromaticity can be adjusted by increasing the blending proportion of dark malt as the malt, increasing the temperature during boiling treatment, increasing boiling time, performing decoction during preparation of a saccharified liquid, and the like. The chromaticity can also be adjusted to a higher level by increasing the original wort extract concentration or increasing the malt proportion.

The beer-flavored beverage according to an aspect of the present invention only needs to be a mode in which the beverage is filled in a container, and examples of the container include a bottle, a PET bottle, a can, a bottle can, and a barrel. In particular, from the viewpoint of easy portability, the container is preferably a bottle, a PET bottle, a can, or a bottle can.

### 1.1 Ingredient

As the main ingredient of the beer-flavored beverage according to an aspect of the present invention, malt may be used together with water, or malt does not need to be used. Further, the beer-flavored beverage according to an aspect of the present invention may be a beverage using hops as an ingredient, or may be a beverage not using hops.

in addition, a preservative, a sweetener, a water-soluble dietary fiber, a bittering agent or bitterness-imparting agent, an antioxidant, a flavoring, an acidulant, a salt, and the like may be used.

1.1.1 Malt, Grain Other than Malt

When malt is used as the ingredient, the malt refers to malt prepared by germinating seeds of barley and the like, such as barley, wheat, rye, common wild oat, oat, or adlay, drying the germinated seeds, and removing roots, and may be from any production area and of any variety.

The malt used in an aspect of the present invention is preferably barley malt. Barley malt is one of the malts most commonly used as an ingredient for Japanese beer-flavored beverages. Examples of barley include two-rowed barley and six-rowed barley, and any of them may be used. Besides normal malt, colored malt and the like can also be used. When colored malt is used, different types of colored malts may be appropriately used in combination, or one colored malt may be used.

In the beer-flavored beverage according to an aspect of the present invention, the malt to be used is preferably selected as appropriate in accordance with the desired chromaticity of the beer-flavored beverage, and the malt to be selected may be used alone or in combination of two or more thereof.

In addition to or instead of malt, a grain other than malt may be used.

Examples of such a grain include barley and the like that do not fall under malt (such as barley, wheat, rye, common wild oats, oats, and adlay), rice (such as white rice and brown rice), corn, kaoliang, potato, legumes (such as soybeans and peas), buckwheat, sorghum, foxtail millet, Japanese millet, starch resulting therefrom, and extracts thereof.

In the case of suppressing the malt proportion or not using malt, it is preferable to increase amounts of ingredients (carbon source and nitrogen source) other than malt that can be utilized by yeast. Examples of the carbon source of the ingredient that can be utilized by yeast include monosaccharides, disaccharides, trisaccharides, and syrups thereof, and examples of the nitrogen source include yeast extract, amino acid-containing materials (such as soybean protein), soybean, yeast extract, pea, wheat malt, the ungerminated grains described above, and decomposition products thereof. Although wheat malt may be used here, it is preferable not to use wheat malt from the viewpoint of allergen.

The beer-flavored beverage according to an aspect of the present invention may be a beverage containing substantially no soybean peptide having a weight-average molecular weight of less than 10000 as an ingredient, or may be a beverage containing no soybean peptide described above.

The “beverage containing substantially no soybean peptide” means a beverage in which the soybean peptide is used in an amount less than 5.0 mass %, less than 3.0 mass %, less than 2.0 mass %, less than 1.0 mass %, less than 0.10 mass %, less than 0.01 mass %, less than 0.001 mass %, or less than 0.0001 mass %, with respect to the total amount (100 mass %) of ingredients excluding water of the beverage.

The fruit, pericarp, bark, leaf, flower, stem, root, and seed of a plant other than plants of the Gramineae family such as barley, which can be used as an ingredient, can be appropriately selected.

Specific examples of the plant other than plants of the Gramineae family include citrus fruits, soft fruits, herbs, and spices. Examples of the citrus fruits include an orange, Citrus junos, a lemon, a lime, a mandarin orange, a grapefruit, Citrus Iyo Group, Citrus japonica, Citrus sphaerocarpa, Citrus limetta ‘Daidai’, Citrus depressa, and Citrus sudachi.

Examples of the soft fruits include a peach, a grape, a banana, an apple, a pineapple, a strawberry, a pear, a muscat, and a blackcurrant. Examples of the herbs and the spices include coriander, pepper, fennel, Sichuan pepper, zanthoxyli fructus, cardamom, caraway, nutmeg, mace, juniper berry, allspice, vanilla, elderberry, grains of paradise, anise, and star anise.

These may be used as they are, may be used after being crushed, may be used in the form of an extract derived by extraction with an extraction solvent such as water or ethanol, or may be used after being squeezed (fruit juice or the like). One of these may be used alone, or two or more thereof may be used in combination.

The above can be used as appropriate in accordance with the preference of the consumers, but to enjoy a clear and refreshing flavor like beer, it is preferable that the aforementioned citrus fruits, soft fruits, herbs, and spices are not used at all or used in a minimum amount as ingredients. In particular, a blackcurrant gives an inappropriate milky aroma in beer, and thus a blackcurrant or blackcurrant juice is preferably not used at all or used in a minimum amount in the ingredient.

### 1.1.2 Hops

When hops are used in an aspect of the present invention, examples of the form of the hops include pellet hops, powdered hops, and hop extract. The hops to be used may be a processed hop product, such as isomerized hops or reduced hops.

When hops are used in an aspect of the present invention, the amount of hops to be added is appropriately adjusted but is preferably from 0.0001 to 1 mass % based on the total amount (100 mass %) of the ingredients for the beverage.

A beer-flavored beverage made using hops as an ingredient is a beverage containing iso-α-acid, which is a component derived from hops. The iso-α-acid content in the beer-flavored beverage made using hops may be more than 0.1 ppm by mass or more than 1.0 ppm by mass based on the total amount (100 mass %) of the beer-flavored beverage.

On the other hand, the iso-α-acid content in a beer-flavored beverage made without using hops may be 0.1 ppm by mass or less based on the total amount (100 mass %) of the beer-flavored beverage.

In the present specification, the iso-α-acid content means a value measured by the high-performance liquid chromatography (HPLC) analysis method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

### 1.1.3 Preservative

The beer-flavored beverage according to an aspect of the present invention may be a beverage in which a preservative is blended.

Examples of the preservative used in an aspect of the present invention include benzoic acid; benzoate salts, such as sodium benzoate; benzoate esters, such as propyl parahydroxybenzoate and butyl parahydroxybenzoate; and dimethyl dicarbonate. As the preservative, a commercially available preparation, such as Kyohryoku Sanpurezah (Powerful Sanplezer) (a mixture of sodium benzoate and butyl benzoate, available from San-Ei Gen F.F.I., Inc.) may be used.

One of these preservatives may be used alone, or two or more of these preservatives may be used in combination.

In the case of blending a preservative in the beer-flavored beverage according to an aspect of the present invention, the blending amount of the preservative is preferably from 5 to 1200 ppm by mass, more preferably from 10 to 1100 ppm by mass, still more preferably from 15 to 1000 ppm by mass, even more preferably from 20 to 900 ppm by mass.

### 1.1.4 Sweetener

The beer-flavored beverage according to an aspect of the present invention may be a beverage in which the content of the saccharides (A) is adjusted to the above-described range and a sweetener is further blended.

Examples of the sweetener used in an aspect of the present invention include saccharified liquid in which starch derived from grain has been degraded with an acid, an enzyme, or the like; saccharides such as commercially available starch syrup; sucrose; tri- or higher saccharides; isomerized sugar; sugar alcohols; natural sweeteners, such as stevia; and artificial sweeteners.

One of these sweeteners may be used alone, or two or more of these sweeteners may be used in combination.

These saccharides may be in the form of a liquid, such as a solution, or a solid, such as a powder.

There are no particular limitations on the type of ingredient grain for starch, the method of purifying starch, and the conditions for treatment, such as hydrolysis with an enzyme or an acid. For example, a saccharide may be used with the proportion of maltose increased by appropriately setting conditions for hydrolysis with an enzyme or an acid. In addition, sucrose, fructose, glucose, maltose, trehalose, maltotriose, maltotetraose, isomaltose, isomaltotriose, isomaltotetraose, and solutions thereof (syrups) can also be used.

Examples of the artificial sweetener include aspartame, acesulfame potassium (acesulfame K), sucralose, and neotame.

### 1.1.5 Water-Soluble Dietary Fiber

The beer-flavored beverage according to an aspect of the present invention may be a beverage in which a water-soluble dietary fiber is blended, or may be a beverage in which no water-soluble dietary fiber is blended (added).

Examples of the water-soluble dietary fiber include indigestible dextrin, indigestible glucan, polydextrose, guar gum degradation products, pectin, glucomannan, alginic acid, laminarin, fucoidin, and carrageenan. From the viewpoint of versatility, such as stability and safety, indigestible dextrin or polydextrose is preferable.

The beer-flavored beverage according to an aspect of the present invention may be a beverage in which no indigestible dextrin is blended (added) as an ingredient. The beer-flavored beverage according to this aspect contains a water-soluble dietary fiber derived from ingredients (for example, malt and the like) without blending (adding) indigestible dextrin. The content of water-soluble dietary fiber derived from ingredients is described in, for example, Standard Tables of Food Composition in Japan 2020 (eighth revised edition).

The beer-flavored beverage according to an aspect of the present invention may be a beverage containing no indigestible glucan or a beverage containing indigestible glucan.

In the beer-flavored beverage according to an aspect of the present invention, the content of the water-soluble dietary fiber may be, based on the total amount (100 mass %) of the beer-flavored beverage, 0.05 mass % or more, 0.1 mass % or more, 0.15 mass % or more, 0.2 mass % or more, 0.25 mass % or more, 0.3 mass % or more, 0.35 mass % or more, 0.4 mass % or more, 0.5 mass % or more, 0.7 mass % or more, 1.0 mass % or more, 1.5 mass % or more, 2.0 mass % or more, 2.5 mass % or more, or 3.0 mass % or more, and it may be 5.0 mass % or less, 4.5 mass % or less, 4.0 mass % or less, 3.5 mass % or less, 3.0 mass % or less, 2.5 mass % or less, 2.0 mass % or less, less than 1.5 mass %, less than 1.0 mass %, less than 0.75 mass %, less than 0.60 mass %, less than 0.50 mass %, 0.40 mass % or less, 0.35 mass % or less, 0.30 mass % or less, 0.25 mass % or less, 0.20 mass % or less, 0.15 mass % or less, 0.10 mass % or less, or less than 0.10 mass %.

The content of the water-soluble dietary fiber may be adjusted to fall within the aforementioned range by adding a commercially available product, or may be adjusted in the production process in such a manner that the content of the dietary fiber derived from an ingredient such as malt falls within the aforementioned range. In the case of adding a commercially available product, when the content of the water-soluble dietary fiber is within the above-described range, powderiness unsuitable for a beer-flavored beverage can be suppressed. In the case of adjusting the content of the dietary fiber in the production process, when the content of the water-soluble dietary fiber is set within the aforementioned range, for example, the filterability in wort filtration or beer filtration can be improved to increase the production efficiency.

In the case of adjusting the content of water-soluble dietary fiber in the production process, the content of water-soluble dietary fiber in the beer-flavored beverage according to an aspect of the present invention can be adjusted by adjusting the addition of diluting water or carbonated water, the type of ingredients (such as barley, malt, corn, and syrup), the amount of ingredient, the type of enzyme, the amount of enzyme added, the timing of enzyme addition (such as during the saccharification step, before addition of yeast, after addition of yeast, and during aging), the set temperature, pH, and retention time in each temperature region in preparing the saccharified liquid, and the like.

### 1.1.6 Bittering Agent and Bitterness-Imparting Agent

The beer-flavored beverage according to an aspect of the present invention may be a beverage further containing one or more selected from the group consisting of a bittering agent and a bitterness-imparting agent.

In the beer-flavored beverage according to an aspect of the present invention, the bitterness may be imparted by hops, or a bittering agent or a bitterness-imparting agent indicated below may be used together with hops. Alternatively, the bittering agent or bitterness-imparting agent indicated below may be used instead of hops without using hops.

The bittering agent or bitterness-imparting agent is not particularly limited, and a substance used as a bitterness-imparting agent in ordinary beer and low-malt beer can be used. Examples thereof include rosemary, litchi, caraway, juniper berry, sage, Ganoderma sichuanense, bay laurel, quassin, caffeine, absinthin, naringin, Phellodendron amurense, citrus extract, bitter wood extract, coffee extract, tea extract, bitter gourd extract, lotus embryo extract, Aloe arborescens extract, rosemary extract, litchi extract, laurel extract, sage extract, caraway extract, Artemisia absinthium extract, absinthin, and alginic acid.

One of these bittering agents and bitterness-imparting agents may be used alone, or two or more of these bittering agents and bitterness-imparting agents may be used in combination.

### 1.1.7 Antioxidant

The beer-flavored beverage according to an aspect of the present invention may be a beverage further containing an antioxidant.

The antioxidant is not particularly limited, and a substance used as an antioxidant in ordinary beer and low-malt beer can be used, and examples include ascorbic acid, erythorbic acid, and catechin.

One of these antioxidants may be used alone, or two or more of these antioxidants may be used in combination.

### 1.1.8 Flavoring

The beer-flavored beverage according to an aspect of the present invention may be a beverage further containing a flavoring.

The flavoring is not particularly limited, and a general beer flavoring can be used. The beer flavoring is used for imparting a beer-like flavor.

Examples of the flavor component contained in the beer flavoring include ester and higher alcohol. Specific examples thereof include isoamyl acetate, ethyl acetate, n-propanol, isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineole, 1,8-cineole, 2,3-diethyl-5-methylpyrazine, γ-decanolactone, γ-undecalactone, ethyl hexanoate, ethyl 2-methyl butyrate, ethyl n-butyrate, myrcene, limonene, maltol, ethyl maltol, phenylacetic acid, furaneol, furfural, methional, 3-methyl-2-butene-1-thiol, 3-methyl-2-butanethiol, diacetyl, ferulic acid, geranic acid, geranylacetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, ethyl 3-phenylpropionate, 2-ethyl-4-hydroxy-5-methyl-3(2H)-furanone, dimethylsulfone, 3-methylcyclopentan-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octen-3-ol, β-eudesmol, 4-mercapto-4-methylpentan-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-butene-1-one, trans-2-hexenal, nonanal, and phenethyl alcohol.

One of these flavorings may be used alone, or two or more of these flavorings may be used in combination.

The content of the flavor component such as ester or higher alcohol can be adjusted by separately adding a flavoring containing these flavor components. However, when alcoholic fermentation is involved in the production process, the content may be adjusted by alcoholic fermentation without adding a flavoring or together with addition of a flavoring.

The content of the flavor component such as ester or higher alcohol in the case of involving alcoholic fermentation can be controlled by appropriately setting the addition of diluting water or carbonated water, the sugar composition and amino acid composition of the pre-fermentation liquid before addition of yeast, sugar concentration, amino acid concentration, original extract concentration in the pre-fermentation liquid, yeast species, fermentation conditions (such as oxygen concentration, aeration conditions, yeast species, amount of yeast added, the number of yeast grown, removal timing of yeast, fermentation temperature, fermentation time, pressure setting, and carbon dioxide concentration), cooling timing, and the like.

### 1.1.9 Acidulant

The beer-flavored beverage according to an aspect of the present invention may be a beverage in which an acidulant is further blended.

The acidulant is not particularly limited as long as it is a substance with sourness, and examples include tartaric acid, gluconic acid, phytic acid, glucono-delta-lactone, and salts thereof.

Among these, at least one selected from tartaric acid, gluconic acid, phytic acid, and salts thereof is preferable, and at least one selected from tartaric acid and salts thereof is more preferable.

One of these acidulants may be used alone, or two or more of these acidulants may be used in combination.

### 1.1.10 Salt

The beer-flavored beverage according to an aspect of the present invention may be a beverage in which salts are further blended.

Examples of the salt include sodium chloride, acid potassium phosphate, acid calcium phosphate, ammonium phosphate, magnesium sulfate, calcium sulfate, potassium metabisulfite, calcium chloride, magnesium chloride, potassium nitrate, ammonium sulfate, potassium chloride, monosodium citrate, disodium citrate, and trisodium citrate.

One of these salts may be used alone, or two or more of these salts may be used in combination.

### 1.2 Carbon Dioxide Gas

As the carbon dioxide gas contained in the beer-flavored beverage according to an aspect of the present invention, carbon dioxide gas contained in an ingredient may be used, or carbon dioxide gas may be dissolved by mixing with carbonated water, addition of carbon dioxide gas, or the like.

The carbon dioxide gas generated in the fermentation step of the beer-flavored beverage can be used as it is, but the amount of the carbon dioxide gas may be adjusted by appropriately adding carbonated water.

The carbon dioxide gas concentration of the beer-flavored beverage according to an aspect of the present invention is preferably 0.30 (w/w) % or more, more preferably 0.35 (w/w) % or more, still more preferably 0.40 (w/w) % or more, even more preferably 0.42 (w/w) % or more, even more preferably 0.45 (w/w) % or more, still further preferably 0.47 (w/w) % or more, particularly preferably 0.50 (w/w) % or more, and preferably 0.80 (w/w) % or less, more preferably 0.70 (w/w) % or less, still more preferably 0.60 (w/w) % or less, even more preferably 0.57 (w/w) % or less, particularly preferably 0.55 (w/w) % or less.

In the present specification, the carbon dioxide gas concentration can be measured in a process in which a container that contains a target beverage is immersed in a water tank at 20° C. for 30 minutes or longer with being shaken from time to time so that the temperature of the beverage becomes 20° C. and then the concentration is measured with a gas volume analyzer (e.g., GVA-500 (available from Kyoto Electronics Manufacturing Co., Ltd.) etc.).

When the beer-flavored beverage according to an aspect of the present invention is a packaged beverage, the carbon dioxide gas pressure of the packaged beverage only needs to be appropriately adjusted such that the carbon dioxide gas concentration is in the ranges described above. The carbon dioxide gas pressure may be 5.0 kg/cm² or less, 4.5 kg/cm² or less, or 4.0 kg/cm² or less, and it may be 0.20 kg/cm² or more, 0.50 kg/cm² or more, or 1.0 kg/cm² or more. Any of these upper and lower limits may be combined. For example, the carbon dioxide gas pressure of the beverage may be 0.20 kg/cm² or more and 5.0 kg/cm² or less, 0.50 kg/cm² or more and 4.5 kg/cm² or less, or 1.0 kg/cm² or more and 4.0 kg/cm² or less.

In the present specification, the gas pressure refers to the gas pressure in the container except in special cases.

The pressure can be measured by a method well-known to those skilled in the art, for example, using a method in which a sample adjusted to 20° C. is fixed to a gas internal pressure meter, the stopcock of the gas internal pressure meter is opened once to release the gas, the stopcock is closed again, the gas internal pressure meter is shaken, and a value when the pointer reaches a certain position is read; or using a commercially available gas pressure measuring instrument.

### 1.3 Other Additives

In the beer-flavored beverage according to an aspect of the present invention, various additives may be added as necessary to the extent that the effects of the present invention are not compromised.

Examples of such additives include coloring agents, foaming agents, fermentation accelerators, yeast extracts, protein-based substances such as peptide-containing substances, and seasonings such as amino acids.

The coloring agent is used to impart a beer-like color to the beverage, and a caramel pigment or the like can be used. The foaming agent is used to form beer-like foam or to keep the foam of the beverage, and a plant-extracted saponin-based substance, such as soybean saponin and/or quillaja saponin; a plant protein, such as corn and/or soybean; a peptide-containing substance, such as a collagen peptide; a yeast extract; an emulsifiers (sucrose fatty acid ester, glycerin fatty acid ester, lecithin, and/or lysolecithin); and the like can be appropriately used.

The fermentation accelerator is used for promoting fermentation by yeasts, and examples thereof include a yeast extract, a bran component such as rice and barley and the like, a vitamin, and a mineral agent. A single type of fermentation accelerator can be used alone or two or more thereof may be used in combination.

### 1.4 Packaged Beverage

The beer-flavored beverage according to an aspect of the present invention may be a packaged beverage packaged in a container. For the packaged beverage, a container of any form and material may be used, and examples of the container include a bottle, a can, a bottle can, a barrel, or a PET bottle. In particular, from the viewpoint of easy portability, the container is preferably a can, a bottle can, a bottle, or a PET bottle.

### 2 Method for Producing Beer-Flavored Beverage

A method for producing a beer-flavored beverage according to an aspect of the present invention is preferably a method including at least the following step (I), more preferably a method including the following steps (I) to (IV), still more preferably a method including the following steps (I) to (V).
Step (I): a step of adjusting or confirming the isomaltotriose content
Step (II): a step of adjusting or confirming the alcohol by volume
Step (III): a step of adjusting or confirming the pH
Step (IV): a step of adjusting or confirming the apparent fermentation degree
Step (V): a step of adjusting or confirming the total content of acids consisting of phosphoric acid, citric acid, pyruvic acid, malic acid, succinic acid, lactic acid, formic acid, acetic acid, and pyroglutamic acid, and/or the content of one or more of these acids

The order of steps (I) to (V) is not particularly limited.

Steps (I) to (V) are for confirming whether the respective physical property values of the beer-flavored beverage are within the above-described ranges. When each physical property value is not within the desired range, adjustment can be performed based on the above-described method.

In step (I), when the isomaltotriose content is less than the desired range, the isomaltotriose content can be adjusted by addition, and when the isomaltotriose content is more than the desired range, the isomaltotriose content can be adjusted by dilution.

In addition, as in step (I), a step of adjusting or confirming the content of isomaltose and/or panose may be included. The specific method of this step is the same as that of step (I).

In addition, when the alcohol by volume in step (II) is lower than the desired range, the alcohol by volume can be adjusted by adding spirits, brewed alcohol, or the like, and when the alcohol by volume is higher than the desired range, the alcohol by volume can be adjusted by dilution.

Steps (III) and (V) may be performed simultaneously. That is, the pH of step (III) can be adjusted by adjusting the content of the various acids described in step (V). The content of various acids in step (V) may be adjusted in the production process of the beer-flavored beverage, but can also be adjusted by adding various acids, whereby the pH in step (III) can also be adjusted.

Step (IV) can be adjusted through a fermentation step. In the present specification, when production is performed without a fermentation step, the apparent fermentation degree is adjusted to 0%.

The method for producing a beer-flavored beverage according to an aspect of the present invention is not particularly limited, and it may be a method for producing a beer-flavored beverage through a fermentation step or may be a method for producing a beer-flavored beverage without a fermentation step.

Hereinafter, a method for producing a fermented beer-flavored beverage through a fermentation step and a method for producing a non-fermented beer-flavored beverage without a fermentation step will be described.

### 2.1 Method for Producing Fermented Beer-Flavored Beverage

Examples of the method for producing a fermented beer-flavored beverage according to an aspect of the present invention include a method involving a fermentation step using yeast, and examples thereof include a method including the following steps (1) to (2) in addition to one or more steps selected from steps (I) to (V) described above.
Step (1): a step of producing a pre-fermentation liquid by conducting, using various ingredients, at least one treatment selected from saccharification treatment, boiling treatment, and solids content removal treatment
Step (2): a step of conducting alcoholic fermentation by adding yeast to the pre-fermentation liquid

In the method for producing a fermented beer-flavored beverage according to an aspect of the present invention, steps (I) to (V) and the adjustment of the sugar content, the ethyl acetate content, the total polyphenol amount, the bitterness value, and the chromaticity can be performed at any one or more timings of the following (i) to (iii). When steps (I) to (V) and the adjustment described above can be performed at the same time by performing the steps (1) and (2), it is not necessary to separately perform these steps.
(i): Simultaneously with at least one of step (1) and step (2)
(ii): In between step (1) and step (2)
(iii): After step (2)

Hereinafter, each step of the method for producing a fermented beer-flavored beverage according to an aspect of the present invention will be described.

### 2.1.1 Step (1)

Step (1) is a step of producing a pre-fermentation liquid by conducting, using various ingredients, at least one treatment selected from saccharification treatment, boiling treatment, and solids content removal treatment.

For example, when malt is used as an ingredient, various ingredients including water and malt are fed in a preparation kettle or a preparation tank, and an enzyme such as amylase is added as necessary. Examples of various ingredients that may be added besides malt include hops, a preservative, a sweetener, a water-soluble dietary fiber, a bittering agent or bitterness-imparting agent, an antioxidant, a flavoring, an acidulant, a pigment, and the like. These ingredients may be added before performing the saccharification treatment, during the saccharification treatment, or after completion of the saccharification treatment. These ingredients may be added after the fermentation in the next step.

A mixture of the various ingredients is heated to saccharify the starch of the ingredients to perform saccharification treatment.

The temperature and time of the saccharification treatment are preferably appropriately adjusted in view of the type of malt used, the malt proportion, ingredients besides water and malt, the type and amount of the enzyme used, the original wort extract concentration of the finally resulting beverage, and the like. In an aspect of the present invention, from the viewpoint of adjusting the sugar concentration and turbidity of the beer-flavored beverage to the aforementioned ranges, the temperature of the saccharification treatment is preferably from 55 to 75° C., and the time of the saccharification treatment is preferably from 30 to 240 minutes.

The saccharified liquid is preferably subjected to boiling treatment.

When hops, a bittering agent, and the like are used as ingredients in the boiling treatment, they are preferably added at the time when this boiling treatment is performed. Hops, a bittering agent, and the like may be added between the start of boiling the saccharified liquid and before the completion of the boiling.

After completion of the boiling treatment, it is preferable that the liquid is transferred to a whirlpool and cooled to 0 to 23° C. to form a cooled liquid, and then a treatment for removing solids content such as coagulated protein is performed. With this treatment, the original wort extract concentration can be adjusted to the aforementioned range. A pre-fermentation liquid is thus prepared.

In this step, there may be performed a filtration through a filter having a predetermined pore diameter (e.g., a pore diameter less than 30 μm) to perform a process for removing solids content.

In place of the saccharified liquid, a malt extract added with warm water may be used, and this liquid is added with hops, a bittering agent, and the like and then subjected to boiling treatment to prepare a pre-fermentation liquid.

When malt is not used as an ingredient, a pre-fermentation liquid may be prepared by mixing, a liquid sugar containing a carbon source; a nitrogen source as an amino acid-containing ingredient other than barley and the like or malt; hops; a dietary fiber; a preservative; a sweetener; an antioxidant; a bitterness-imparting agent; a flavoring; an acidulant; a pigment; and the like together with warm water to prepare a liquid syrup, and boiling the liquid syrup.

When hops are used, they may be added before the boiling treatment or may be added between the start of boiling the liquid syrup and before the completion of the boiling.

### 2.1.2 Step (2)

Step (2) is a step of conducting alcoholic fermentation by adding yeast to the pre-fermentation liquid obtained in step (1).

The yeast used in this step can be appropriately selected in view of the type of the fermented beverage to be produced, the target flavor, the fermentation conditions, and the like, and top-fermenting yeast may be used, or bottom-fermenting yeast may be used.

The yeast in the form of a yeast suspension as is may be added to the ingredient liquid, or a slurry produced by concentrating the yeast by centrifugation or sedimentation may be added to the stock solution. Alternatively, a material obtained by completely removing the supernatant after the centrifugation may be added. The amount of yeast added to the stock solution can be appropriately set and is, for example, approximately from 5.0×10⁶ cells/mL to 1.0×10⁹ cells/mL.

The fermentation conditions in performing fermentation can be set as appropriate, but the fermentation temperature is preferably from 5 to 25° C. from the viewpoint of adjusting the sugar content and the alcohol by volume of the beer-flavored beverage to the ranges described above. The sugar content and the alcohol by volume of the beer-flavored beverage can be adjusted by appropriately setting the type, amount, and timing of addition of the polysaccharide-degrading enzyme such as transglucosidase. They can be also adjusted by changing the temperature (temperature increase or temperature decrease) or pressure of the fermented liquid during the fermentation step as necessary.

After the fermentation, filtration treatment for removing yeast in the beer-flavored beverage may be performed, or filtration treatment does not need to be performed. In addition, water or the above-described various additives may be added as necessary.

### 2.1.3 Step (3), Step (4)

In an aspect of the present invention, when a non-alcohol fermented beer-flavored beverage is produced, the beverage may be produced through a step of non-alcoholic fermentation using yeast that does not produce alcohol. In this case, yeast that does not produce alcohol needs to be used in step (2).

When a non-alcohol fermented beer-flavored beverage is produced using yeast that produces alcohol, it is preferable to further perform steps (3) and (4) together with steps (1) and (2):
Step (3): a step of removing an alcohol by volume from the fermentation liquid after step (2)
Step (4): a step of adjusting the amount of carbon dioxide gas after step (3)

In step (3), as a method for removing the alcohol by volume produced in the fermentation step of step (2), a method for removing the alcohol by volume through heat treatment is preferable. As conditions for the heat treatment, conditions similar to those in a general method for producing a non-alcohol beer-flavored beverage can be applied.

After step (3), the alcohol by volume is removed from the solution and carbon dioxide gas is also removed. Therefore, the amount of carbon dioxide gas is preferably adjusted through step (4).

As a method for adjusting the amount of carbon dioxide gas, carbon dioxide gas may be added by mixing the solution after step (3) with carbonated water, or carbon dioxide gas may be directly added to the solution that has undergone step (3).

The beer-flavored beverage thus produced according to an aspect of the present invention is filled in a predetermined container and distributed to the market as a product.

The method of packaging the beer-flavored beverage is not particularly limited, and a packaging method known to those skilled in the art can be used. Through a packaging step, the beer-flavored beverage according to the present invention is filled and sealed in a container. In the packaging step, a container of any form and material may be used, and examples of the container include containers described in “1.4 Packaged beverage”.

### 2.2 Method for Producing Non-Fermented Beer-Flavored Beverage

A method for producing a non-fermented beer-flavored beverage according to an aspect of the present invention only needs to be a method without a fermentation step, and includes, for example, the following steps (a) to (c):
Step (a): a step of producing a pre-beverage liquid by conducting, for the ingredients, at least one process selected from a saccharification process, a boiling treatment, and a solids content removal treatment
Step (b): a step of cooling the pre-beverage liquid obtained in step (a) and adding carbon dioxide gas

Step (a) is the same as the step of producing a pre-fermentation liquid of step (1) in “Method for producing fermented beer-flavored beverage” described above.

As a method for adding carbon dioxide gas in step (b), carbon dioxide gas may be added by mixing the cooled pre-beverage liquid formed by cooling the pre-beverage liquid produced in step (a) with carbonated water, or carbon dioxide gas may be directly added to the cooled beverage stock solution. At the same timing as step (b), additives such as a preservative, a sweetener, a flavoring, an acidulant, and a pigment may be added as necessary in adding carbon dioxide gas.

When the non-fermented beer-flavored beverage is produced as a non-fermented alcohol-containing beer-flavored beverage, the method includes the following step (c):
Step (c): a step of blending an alcohol component at least after step (a)

Step (c) needs to be performed at least after step (a), and can be performed, for example, at one or more timings of any of the following (α), (β), and (γ).
(α): In between step (a) and step (b)
(β): At the same time as step (b)
(γ): After step (b)

Among these, step (c) is preferably performed after the pre-beverage liquid produced in step (a) is cooled to prepare a cooled beverage stock solution and before carbon dioxide gas is added.

As the alcohol component to be blended in step (c), spirits (distilled liquor) derived from the above-described grains is preferable.

In the method for producing a non-fermented beer-flavored beverage according to an aspect of the present invention, steps (I) to (V) and the adjustment of the sugar content, the ethyl acetate content, the total polyphenol amount, the bitterness value, and the chromaticity can be performed at any one or more timings of the following (i) to (v). When steps (I) to (V) and the above-described adjustment can be simultaneously performed by performing steps (a) to (c), it is not necessary to separately perform these steps.
(i): Simultaneously with at least one of step (a), step (b), and step (c)
(ii): Between step (a) and step (b)
(iii): Between step (a) and step (c)
(iv): After step (b) or between step (b) and step (c)
(v): After step (c)

The non-fermented beer-flavored beverage thus produced is filled in a predetermined container and distributed to the market as a product.

The method for packaging the non-fermented beer-flavored beverage is not particularly limited, and a packaging method known to those skilled in the art can be used. Through the packaging step, the non-fermented beer-flavored beverage is filled and sealed in a container. In the packaging step, a container of any form and material may be used, and examples of the container include those described above.

### 3. Method for Improving Aftertaste Suitable for Beer-Flavored Beverage and Method for Suppressing an Unsuitable Watery Taste

As an aspect of the present invention, the following methods (1) and (2) are also provided.
(1) A method for improving the aftertaste suitable for a beer-flavored beverage, the beer-flavored beverage having an alcohol by volume of 5.0 (v/v) % or less, by adding isomaltotriose (hereinafter, also referred to as “aftertaste improvement method”)
(2) A method for suppressing a watery taste unsuitable for a beer-flavored beverage, the beer-flavored beverage having an alcohol by volume of 5.0 (v/v) % or less, the method including adjusting the total content of acids consisting of phosphoric acid, citric acid, pyruvic acid, malic acid, succinic acid, lactic acid, formic acid, acetic acid, and pyroglutamic acid (hereinafter, also referred to as “watery taste suppression method”)

The isomaltotriose content in the aftertaste improvement method according to an aspect of the present invention, the total content of phosphoric acid, citric acid, pyruvic acid, malic acid, succinic acid, lactic acid, formic acid, acetic acid, and pyroglutamic acid and the content of each acid in the watery taste suppression method according to an aspect of the present invention, and the various properties, various components, the content thereof, and the like of the beer-flavored beverage in these methods are as described in “1. Beer-flavored beverage” above.

### EXAMPLES

Hereinafter, the present invention will be described in more detail by Examples, but the present invention is not limited by these Examples.

### Examples 1 to 32 and Comparative Examples 1 to 19

### <Preparation of Beverage>

Crushed barley malt was fed in a preparation tank containing 100 L of warm water kept at 40 to 55° C., then the temperature was raised to 78° C. while the temperature was repeatedly raised and kept in stages, then malt dregs were removed by filtration, and a saccharified liquid was produced. Next, hops were further added to the saccharified liquid, boiling was performed, and solid-liquid separation treatment was performed to obtain clear wort. Then, brewer's yeast was added to the pre-fermentation liquid formed by cooling the wort, and the fermentation temperature and the fermentation time were adjusted to perform alcoholic fermentation. Then, the yeast was removed by filtration to produce a beverage that would be categorized as beer in the Liquor Tax Law. The produced beverage had a real extract concentration of from 2.5 to 5.1 g/100 mL, a sugar content of from 2.5 to 4.5 g/100 mL, an ethyl acetate content of from 8 to 17 ppm by mass, a total polyphenol amount of from 80 to 150 ppm by mass, a bitterness value of from 14 to 30 BUs, and a chromaticity of from 6 to 12 EBC.

In each of Examples and Comparative Examples, the type of barley malt as an ingredient, the set temperature and the retention time in each temperature region in preparing the saccharified liquid, the presence or absence of addition of an enzyme and the timing when an enzyme is added, the fermentation temperature and the fermentation time, and the like were appropriately set, and the alcohol by volume, the apparent fermentation degree, the isomaltotriose content, the pH, the free amino nitrogen (FAN) content, and the content of each acid component were adjusted to values listed in Tables 1 to 5. The isomaltotriose content was adjusted to the values listed in Tables 1 to 5 by adding isomaltotriose as necessary in addition to the setting of the aforementioned conditions.

### <Sensory Evaluation>

Five panelists who had been regularly trained evaluated the beverages obtained in Examples and Comparative Examples cooled to approximately 4° C. for “Presence or absence of watery taste unsuitable for a beer-flavored beverage”, “Presence or absence of taste thickness suitable for a beer-flavored beverage” and “Presence or absence of aftertaste suitable for a beer-flavored beverage” of each beverage for testing by a score in a range of 3.0 (maximum value) to 1.0 (minimum value) in increments of 0.1 based on the score criteria described below, and average values of the scores of the five panelists were calculated. The results are listed in Tables 1 to 5.

In the evaluation, samples that meet the following criteria “3.0”, “2.5”, “2.0”, “1.5”, and “1.0” were prepared in advance to standardize the criteria among the panelists. In any of the sensory evaluations in Tables 1 to 5, for the same beverage, no difference in a score value of 1.5 or more was observed among the panelists.

### [Score Criteria for Presence or Absence of Watery Taste Unsuitable for Beer-Flavored Beverage]

“3.0”: Watery taste unsuitable for a beer-flavored beverage is not felt at all.
“2.5”: Watery taste unsuitable for a beer-flavored beverage is hardly felt.
“2.0”: Watery taste unsuitable for a beer-flavored beverage is not felt much.
“1.5”: Watery taste unsuitable for a beer-flavored beverage is felt.
“1.0”: Watery taste unsuitable for a beer-flavored beverage is strongly felt.

### [Score Criteria for Presence or Absence of Taste Thickness Suitable for Beer-Flavored Beverage]

“3.0”: Taste thickness suitable for a beer-flavored beverage is very strongly felt.
“2.5”: Taste thickness suitable for a beer-flavored beverage is strongly felt.
“2.0”: Taste thickness suitable for a beer-flavored beverage is sufficiently felt.
“1.5”: Taste thickness suitable for a beer-flavored beverage is not felt much.
“1.0”: Taste thickness suitable for a beer-flavored beverage is hardly felt.

### [Score Criteria for Presence or Absence of Aftertaste Suitable for Beer-Flavored Beverage]

“3.0”: Aftertaste suitable for beer-flavored beverages is very strongly felt.
“2.5”: Aftertaste suitable for beer-flavored beverages is strongly felt.
“2.0”: Aftertaste suitable for beer-flavored beverages is sufficiently felt.
“1.5”: Aftertaste suitable for beer-flavored beverages is not felt much.
“1.0”: Aftertaste suitable for beer-flavored beverages is hardly felt.

The overall evaluation was made based on the following criteria.

### [Overall Evaluation]

A: All the scores of “Presence or absence of watery taste unsuitable for beer-flavored beverage”, “Presence or absence of taste thickness suitable for beer-flavored beverage”, and “Presence or absence of aftertaste suitable for beer-flavored beverage” are 2.5 or more.
B: Not corresponding to “A” described above or “C”
C: The score of at least one of “Presence or absence of watery taste unsuitable for beer-flavored beverage”, “Presence or absence of taste thickness suitable for beer-flavored beverage”, and “Presence or absence of aftertaste suitable for beer-flavored beverage” is less than 2.0.

TABLE 1

| | | | Exam- | Exam- | Exam- | Exam- | Exam- | Exam- |
|---|---|---|---|---|---|---|---|---|
| | | | ple 1 | ple 2 | ple 3 | ple 4 | ple 5 | ple 6 |
| Alcohol by volume | | v/v % | 2.40 | 2.40 | 2.52 | 2.43 | 2.42 | 2.52 |
| Apparent | | % | 53.1 | 53.1 | 58.5 | 59.2 | 66.2 | 72.0 |
| fermentation degree | | | | | | | | |
| Isomaltotriose content | | g/100 mL | 0.020 | 0.090 | 0.050 | 0.070 | 0.060 | 0.020 |
| pH | | — | 4.41 | 4.41 | 4.41 | 4.41 | 4.41 | 4.41 |
| Isomaltotriose content/ | | — | 0.038 | 0.169 | 0.085 | 0.118 | 0.091 | 0.028 |
| apparent fermentation | | | | | | | | |
| degree × 100 | | | | | | | | |
| FAN content | | mg/100 mL | 13.4 | 13.4 | 8.6 | 12.0 | 9.0 | 7.1 |
| Acid | Phosphoric | ppm by | 468.1 | 468.1 | 431.9 | 411.2 | 368.7 | 372.4 |
| component | acid (a) | mass | | | | | | |
| | Citric | ppm by | 192.3 | 192.3 | 217.3 | 168.2 | 141.3 | 156.3 |
| | acid (b) | mass | | | | | | |
| | Pyruvic | ppm by | 95.4 | 95.4 | 95.3 | 85.1 | 11.1 | 29.7 |
| | acid (c) | mass | | | | | | |
| | Malic | ppm by | 96.1 | 96.1 | 141.1 | 86.0 | 109.7 | 124.7 |
| | acid (d) | mass | | | | | | |
| | Succinic | ppm by | 24.5 | 24.5 | 51.8 | 22.8 | 45.4 | 53.4 |
| | acid (e) | mass | | | | | | |
| | Lactic | ppm by | 175.7 | 175.7 | 226.5 | 157.0 | 172.2 | 176.0 |
| | acid (f) | mass | | | | | | |
| | Formic | ppm by | 3.2 | 3.2 | 4.2 | 2.4 | 1.6 | 1.5 |
| | acid (g) | mass | | | | | | |
| | Acetic | ppm by | 62.6 | 62.6 | 11.6 | 52.0 | 33.5 | 10.0 |
| | acid (h) | mass | | | | | | |
| | Pyroglutamic | ppm by | 143.9 | 143.9 | 140.6 | 129.6 | 119.9 | 115.6 |
| | acid (i) | mass | | | | | | |
| | Total | ppm by | 1261.7 | 1261.7 | 1320.3 | 1114.3 | 1003.4 | 1039.7 |
| | content | mass | | | | | | |
| | of acids | | | | | | | |
| | (a) to (i) | | | | | | | |
| Evaluation | Watery taste unsuitable | | 2.0 | 2.0 | 2.0 | 2.0 | 2.0 | 2.0 |
| item | for beer-flavored beverage | | | | | | | |
| | Taste thickness suitable | | 3.0 | 3.0 | 2.5 | 2.5 | 2.0 | 2.0 |
| | for beer-flavored beverage | | | | | | | |
| | Aftertaste suitable for | | 2.0 | 2.5 | 2.5 | 2.5 | 2.5 | 2.0 |
| | beer-flavored beverage | | | | | | | |
| | Overall evaluation | | B | B | B | B | B | B |
| | | | | | Compar- | Compar- | Compar- | Compar- |
| | | | | | ative | ative | ative | ative |
| | | | Exam- | Exam- | Exam- | Exam- | Exam- | Exam- |
| | | | ple 7 | ple 8 | ple 1 | ple 2 | ple 3 | ple 4 |
| Alcohol by volume | | v/v % | 2.52 | 2.52 | 2.40 | 2.52 | 2.36 | 2.36 |
| Apparent | | % | 72.0 | 72.0 | 53.1 | 72.0 | 87.6 | 87.6 |
| fermentation degree | | | | | | | | |
| Isomaltotriose content | | g/100 mL | 0.090 | 0.070 | 0.010 | 0.010 | 0.020 | 0.090 |
| pH | | — | 4.41 | 4.41 | 4.41 | 4.41 | 4.41 | 4.41 |
| Isomaltotriose content/ | | — | 0.125 | 0.097 | 0.019 | 0.014 | 0.023 | 0.103 |
| apparent fermentation | | | | | | | | |
| degree × 100 | | | | | | | | |
| FAN content | | mg/100 mL | 7.1 | 7.1 | 5.0 | 2.8 | 5.7 | 5.7 |
| Acid | Phosphoric | ppm by | 372.4 | 372.4 | 365.1 | 197.0 | 229.2 | 229.2 |
| component | acid (a) | mass | | | | | | |
| | Citric | ppm by | 156.3 | 156.3 | 156.8 | 165.7 | 106.2 | 106.2 |
| | acid (b) | mass | | | | | | |
| | Pyruvic | ppm by | 29.7 | 29.7 | 135.9 | 106.2 | 46.3 | 46.3 |
| | acid (c) | mass | | | | | | |
| | Malic | ppm by | 124.7 | 124.7 | 213.1 | 109.1 | 78.6 | 78.6 |
| | acid (d) | mass | | | | | | |
| | Succinic | ppm by | 53.4 | 53.4 | 57.2 | 38.2 | 32.8 | 32.8 |
| | acid (e) | mass | | | | | | |
| | Lactic | ppm by | 176.0 | 176.0 | 203.9 | 152.9 | 107.1 | 107.1 |
| | acid (f) | mass | | | | | | |
| | Formic | ppm by | 1.5 | 1.5 | 2.8 | 1.4 | 1.4 | 1.4 |
| | acid (g) | mass | | | | | | |
| | Acetic | ppm by | 10.0 | 10.0 | 7.9 | 6.3 | 14.5 | 14.5 |
| | acid (h) | mass | | | | | | |
| | Pyroglutamic | ppm by | 115.6 | 115.6 | 117.8 | 111.0 | 84.3 | 84.3 |
| | acid (i) | mass | | | | | | |
| | Total | ppm by | 1039.7 | 1039.7 | 1260.6 | 887.8 | 700.3 | 700.3 |
| | content | mass | | | | | | |
| | of acids | | | | | | | |
| | (a) to (i) | | | | | | | |

| | | | | | | | |
|---|---|---|---|---|---|---|---|
| Evaluation | Watery taste unsuitable | 2.0 | 2.0 | 2.0 | 2.0 | 2.0 | 2.0 |
| item | for beer-flavored beverage | | | | | | |
| | Taste thickness suitable | 2.0 | 2.0 | 3.0 | 2.0 | 1.0 | 1.0 |
| | for beer-flavored beverage | | | | | | |
| | Aftertaste suitable for | 3.0 | 2.5 | 1.5 | 1.5 | 2.0 | 2.5 |
| | beer-flavored beverage | | | | | | |
| | Overall evaluation | B | B | C | C | C | C |

TABLE 2

| | | | Exam- | Exam- | Exam- | Exam- | Exam- | Exam- | Exam- |
|---|---|---|---|---|---|---|---|---|---|
| | | | ple 9 | ple 10 | ple 11 | ple 12 | ple 13 | ple 14 | ple 15 |
| Alcohol by volume | | v/v % | 2.40 | 2.40 | 2.52 | 2.43 | 2.42 | 2.52 | 2.52 |
| Apparent | | % | 53.1 | 53.1 | 58.5 | 59.2 | 66.2 | 72.0 | 72.0 |
| fermentation degree | | | | | | | | | |
| Isomaltotriose content | | g/100 mL | 0.020 | 0.090 | 0.050 | 0.070 | 0.060 | 0.020 | 0.090 |
| pH | | — | 4.53 | 4.53 | 4.50 | 4.53 | 4.52 | 4.52 | 4.52 |
| Isomaltotriose content/ | | — | 0.038 | 0.169 | 0.085 | 0.118 | 0.091 | 0.028 | 0.125 |
| apparent fermentation | | | | | | | | | |
| degree × 100 | | | | | | | | | |
| FAN content | | mg/100 mL | 13.4 | 13.4 | 8.6 | 12.0 | 9.0 | 7.1 | 7.1 |
| Acid | Phosphoric | ppm by | 468.1 | 468.1 | 431.9 | 411.2 | 368.7 | 372.4 | 372.4 |
| component | acid (a) | mass | | | | | | | |
| | Citric | ppm by | 192.3 | 192.3 | 217.3 | 168.2 | 141.3 | 156.3 | 156.3 |
| | acid (b) | mass | | | | | | | |
| | Pyruvic | ppm by | 95.4 | 95.4 | 95.3 | 85.1 | 11.1 | 29.7 | 29.7 |
| | acid (c) | mass | | | | | | | |
| | Malic | ppm by | 96.1 | 96.1 | 141.1 | 86.0 | 109.7 | 124.7 | 124.7 |
| | acid (d) | mass | | | | | | | |
| | Succinic | ppm by | 24.5 | 24.5 | 51.8 | 22.8 | 45.4 | 53.4 | 53.4 |
| | acid (e) | mass | | | | | | | |
| | Lactic | ppm by | 165.3 | 165.3 | 216.2 | 146.7 | 161.8 | 165.7 | 165.7 |
| | acid (f) | mass | | | | | | | |
| | Formic | ppm by | 3.2 | 3.2 | 4.2 | 2.4 | 1.6 | 1.5 | 1.5 |
| | acid (g) | mass | | | | | | | |
| | Acetic | ppm by | 62.6 | 62.6 | 11.6 | 52.0 | 33.5 | 10.0 | 10.0 |
| | acid (h) | mass | | | | | | | |
| | Pyroglutamic | ppm by | 143.9 | 143.9 | 140.6 | 129.6 | 119.9 | 115.6 | 115.6 |
| | acid (i) | mass | | | | | | | |
| | Total | ppm by | 1251.4 | 1251.4 | 1309.9 | 1104.0 | 993.1 | 1029.4 | 1029.4 |
| | content | mass | | | | | | | |
| | of acids | | | | | | | | |
| | (a) to (i) | | | | | | | | |

| | | | | | | | | |
|---|---|---|---|---|---|---|---|---|
| Evaluation | Watery taste unsuitable | 2.0 | 2.0 | 2.0 | 2.0 | 2.0 | 2.0 | 2.0 |
| item | for beer-flavored beverage | | | | | | | |
| | Taste thickness suitable | 3.0 | 3.0 | 2.5 | 2.5 | 2.0 | 2.0 | 2.0 |
| | for beer-flavored beverage | | | | | | | |
| | Aftertaste suitable for | 2.0 | 2.5 | 2.0 | 2.5 | 2.5 | 2.0 | 2.5 |
| | beer-flavored beverage | | | | | | | |
| | Overall evaluation | B | B | B | B | B | B | B |

| | | | | Compar- | Compar- | Compar- | Compar- |
|---|---|---|---|---|---|---|---|
| | | | | ative | ative | ative | ative |
| | | | Exam- | Exam- | Exam- | Exam- | Exam- |
| | | | ple 16 | ple 5 | ple 6 | ple 7 | ple 8 |
| Alcohol by volume | | v/v % | 2.52 | 5.00 | 2.80 | 2.36 | 2.36 |
| Apparent | | % | 72.0 | 53.1 | 72.0 | 87.6 | 87.6 |
| fermentation degree | | | | | | | |
| Isomaltotriose content | | g/100 mL | 0.070 | 0.010 | 0.010 | 0.020 | 0.090 |
| pH | | — | 4.53 | 4.52 | 4.52 | 4.52 | 4.52 |
| Isomaltotriose content/ | | — | 0.097 | 0.019 | 0.014 | 0.023 | 0.103 |
| apparent fermentation | | | | | | | |
| degree × 100 | | | | | | | |
| FAN content | | mg/100 mL | 7.1 | 3.3 | 3.1 | 5.7 | 5.7 |
| Acid | Phosphoric | ppm by | 372.4 | 365.1 | 197.0 | 229.2 | 229.2 |
| component | acid (a) | mass | | | | | |
| | Citric | ppm by | 156.3 | 156.8 | 165.7 | 106.2 | 106.2 |
| | acid (b) | mass | | | | | |
| | Pyruvic | ppm by | 29.7 | 135.9 | 106.2 | 46.3 | 46.3 |
| | acid (c) | mass | | | | | |
| | Malic | ppm by | 124.7 | 213.1 | 109.1 | 78.6 | 78.6 |
| | acid (d) | mass | | | | | |
| | Succinic | ppm by | 53.4 | 57.2 | 38.2 | 32.8 | 32.8 |
| | acid (e) | mass | | | | | |
| | Lactic | ppm by | 165.7 | 193.5 | 142.5 | 96.8 | 96.8 |
| | acid (f) | mass | | | | | |
| | Formic | ppm by | 1.5 | 2.8 | 1.4 | 1.4 | 1.4 |
| | acid (g) | mass | | | | | |
| | Acetic | ppm by | 10.0 | 7.9 | 6.3 | 14.5 | 14.5 |
| | acid (h) | mass | | | | | |
| | Pyroglutamic | ppm by | 115.6 | 117.8 | 111.0 | 84.3 | 84.3 |
| | acid (i) | mass | | | | | |
| | Total | ppm by | 1029.4 | 1250.2 | 877.4 | 690.0 | 690.0 |
| | content | mass | | | | | |
| | of acids | | | | | | |
| | (a) to (i) | | | | | | |

| | | | | | | |
|---|---|---|---|---|---|---|
| Evaluation | Watery taste unsuitable | 2.0 | 2.1 | 2.1 | 2.1 | 2.1 |
| item | for beer-flavored beverage | | | | | |
| | Taste thickness suitable | 2.0 | 3.0 | 2.0 | 1.0 | 1.0 |
| | for beer-flavored beverage | | | | | |
| | Aftertaste suitable for | 2.5 | 1.5 | 1.5 | 2.0 | 2.5 |
| | beer-flavored beverage | | | | | |
| | Overall evaluation | B | C | C | C | C |

TABLE 3

| | | | Exam- | Exam- | Exam- | Exam- | Exam- | Exam- | Exam- |
|---|---|---|---|---|---|---|---|---|---|
| | | | ple 17 | ple 18 | ple 19 | ple 20 | ple 21 | ple 22 | ple 23 |
| Alcohol by volume | | v/v % | 2.40 | 2.40 | 2.52 | 2.43 | 2.42 | 2.52 | 2.52 |
| Apparent | | % | 53.1 | 53.1 | 58.5 | 59.2 | 66.2 | 72.0 | 72.0 |
| fermentation degree | | | | | | | | | |
| Isomaltotriose content | | g/100 mL | 0.020 | 0.090 | 0.050 | 0.070 | 0.060 | 0.020 | 0.090 |
| pH | | — | 4.62 | 4.62 | 4.60 | 4.63 | 4.64 | 4.61 | 4.61 |
| Isomaltotriose content/ | | — | 0.038 | 0.169 | 0.085 | 0.118 | 0.091 | 0.028 | 0.125 |
| apparent fermentation | | | | | | | | | |
| degree × 100 | | | | | | | | | |
| FAN content | | mg/100 mL | 13.4 | 13.4 | 8.6 | 12.0 | 9.0 | 7.1 | 7.1 |
| Acid | Phosphoric | ppm by | 468.1 | 468.1 | 431.9 | 411.2 | 368.7 | 372.4 | 372.4 |
| component | acid (a) | mass | | | | | | | |
| | Citric | ppm by | 192.3 | 192.3 | 217.3 | 168.2 | 141.3 | 156.3 | 156.3 |
| | acid (b) | mass | | | | | | | |
| | Pyruvic | ppm by | 95.4 | 95.4 | 95.3 | 85.1 | 11.1 | 29.7 | 29.7 |
| | acid (c) | mass | | | | | | | |
| | Malic | ppm by | 96.1 | 96.1 | 141.1 | 86.0 | 109.7 | 124.7 | 124.7 |
| | acid (d) | mass | | | | | | | |
| | Succinic | ppm by | 24.5 | 24.5 | 51.8 | 22.8 | 45.4 | 53.4 | 53.4 |
| | acid (e) | mass | | | | | | | |
| | Lactic | ppm by | 157.8 | 157.8 | 208.7 | 139.2 | 148.9 | 158.1 | 158.1 |
| | acid (f) | mass | | | | | | | |
| | Formic | ppm by | 3.2 | 3.2 | 4.2 | 2.4 | 1.6 | 1.5 | 1.5 |
| | acid (g) | mass | | | | | | | |
| | Acetic | ppm by | 62.6 | 62.6 | 11.6 | 52.0 | 33.5 | 10.0 | 10.0 |
| | acid (h) | mass | | | | | | | |
| | Pyroglutamic | ppm by | 143.9 | 143.9 | 140.6 | 129.6 | 119.9 | 115.6 | 115.6 |
| | acid (i) | mass | | | | | | | |
| | Total | ppm by | 1243.8 | 1243.8 | 1302.4 | 1096.4 | 980.1 | 1021.8 | 1021.8 |
| | content | mass | | | | | | | |
| | of acids | | | | | | | | |
| | (a) to (i) | | | | | | | | |

| | | | | | | | | |
|---|---|---|---|---|---|---|---|---|
| Evaluation | Watery taste unsuitable | 2.5 | 2.5 | 2.5 | 2.5 | 2.5 | 2.5 | 2.5 |
| item | for beer-flavored beverage | | | | | | | |
| | Taste thickness suitable | 3.0 | 3.0 | 2.5 | 2.5 | 2.0 | 2.0 | 2.0 |
| | for beer-flavored beverage | | | | | | | |
| | Aftertaste suitable for | 2.0 | 2.5 | 2.0 | 2.5 | 2.5 | 2.0 | 2.5 |
| | beer-flavored beverage | | | | | | | |
| | Overall evaluation | B | A | B | A | B | B | B |

| | | | | Compar- | Compar- | Compar- | Compar- |
|---|---|---|---|---|---|---|---|
| | | | | ative | ative | ative | ative |
| | | | Exam- | Exam- | Exam- | Exam- | Exam- |
| | | | ple 24 | ple 9 | ple 10 | ple 11 | ple 12 |
| Alcohol by volume | | v/v % | 2.52 | 2.40 | 2.52 | 2.36 | 2.36 |
| Apparent | | % | 72.0 | 53.1 | 72.0 | 87.6 | 87.6 |
| fermentation degree | | | | | | | |
| Isomaltotriose content | | g/100 mL | 0.070 | 0.010 | 0.010 | 0.020 | 0.090 |
| pH | | — | 4.60 | 4.61 | 4.61 | 4.61 | 4.61 |
| Isomaltotriose content/ | | — | 0.097 | 0.019 | 0.014 | 0.023 | 0.103 |
| apparent fermentation | | | | | | | |
| degree × 100 | | | | | | | |
| FAN content | | mg/100 mL | 7.1 | 5.0 | 2.8 | 5.7 | 5.7 |
| Acid | Phosphoric | ppm by | 372.4 | 365.1 | 197.0 | 229.2 | 229.2 |
| component | acid (a) | mass | | | | | |
| | Citric | ppm by | 156.3 | 156.8 | 165.7 | 106.2 | 106.2 |
| | acid (b) | mass | | | | | |
| | Pyruvic | ppm by | 29.7 | 135.9 | 106.2 | 46.3 | 46.3 |
| | acid (c) | mass | | | | | |
| | Malic | ppm by | 124.7 | 213.1 | 109.1 | 78.6 | 78.6 |
| | acid (d) | mass | | | | | |
| | Succinic | ppm by | 53.4 | 57.2 | 38.2 | 32.8 | 32.8 |
| | acid (e) | mass | | | | | |
| | Lactic | ppm by | 158.1 | 186.0 | 135.0 | 89.2 | 89.2 |
| | acid (f) | mass | | | | | |
| | Formic | ppm by | 1.5 | 2.8 | 1.4 | 1.4 | 1.4 |
| | acid (g) | mass | | | | | |
| | Acetic | ppm by | 10.0 | 7.9 | 6.3 | 14.5 | 14.5 |
| | acid (h) | mass | | | | | |
| | Pyroglutamic | ppm by | 115.6 | 117.8 | 111.0 | 84.3 | 84.3 |
| | acid (i) | mass | | | | | |
| | Total | ppm by | 1021.8 | 1242.7 | 869.9 | 682.5 | 682.5 |
| | content | mass | | | | | |
| | of acids | | | | | | |
| | (a) to (i) | | | | | | |

| | | | | | | |
|---|---|---|---|---|---|---|
| Evaluation | Watery taste unsuitable | 2.5 | 2.4 | 2.4 | 2.4 | 2.4 |
| item | for beer-flavored beverage | | | | | |
| | Taste thickness suitable | 2.0 | 2.8 | 1.9 | 1.1 | 1.1 |
| | for beer-flavored beverage | | | | | |
| | Aftertaste suitable for | 2.5 | 1.5 | 1.5 | 2.0 | 2.5 |
| | beer-flavored beverage | | | | | |
| | Overall evaluation | B | C | C | C | C |

TABLE 4

| | | | Exam- | Exam- | Exam- | Exam- | Exam- | Exam- | Exam- |
|---|---|---|---|---|---|---|---|---|---|
| | | | ple 25 | ple 26 | ple 27 | ple 28 | ple 29 | ple 30 | ple 31 |
| Alcohol by volume | | v/v % | 2.40 | 2.40 | 2.52 | 2.43 | 2.42 | 2.52 | 2.52 |
| Apparent | | % | 53.1 | 53.1 | 58.5 | 59.2 | 66.2 | 72.0 | 72.0 |
| fermentation degree | | | | | | | | | |
| Isomaltotriose content | | g/100 mL | 0.020 | 0.090 | 0.050 | 0.070 | 0.060 | 0.020 | 0.090 |
| pH | | — | 4.80 | 4.80 | 4.80 | 4.80 | 4.80 | 4.80 | 4.80 |
| Isomaltotriose content/ | | — | 0.038 | 0.169 | 0.085 | 0.118 | 0.091 | 0.028 | 0.125 |
| apparent fermentation | | | | | | | | | |
| degree × 100 | | | | | | | | | |
| FAN content | | mg/100 mL | 13.4 | 13.4 | 8.6 | 12.0 | 9.0 | 7.1 | 7.1 |
| Acid | Phosphoric | ppm by | 468.1 | 468.1 | 431.9 | 411.2 | 368.7 | 372.4 | 372.4 |
| component | acid (a) | mass | | | | | | | |
| | Citric | ppm by | 192.3 | 192.3 | 217.3 | 168.2 | 141.3 | 156.3 | 156.3 |
| | acid (b) | mass | | | | | | | |
| | Pyruvic | ppm by | 95.4 | 95.4 | 95.3 | 85.1 | 11.1 | 29.7 | 29.7 |
| | acid (c) | mass | | | | | | | |
| | Malic | ppm by | 96.1 | 96.1 | 141.1 | 86.0 | 109.7 | 124.7 | 124.7 |
| | acid (d) | mass | | | | | | | |
| | Succinic | ppm by | 24.5 | 24.5 | 51.8 | 22.8 | 45.4 | 53.4 | 53.4 |
| | acid (e) | mass | | | | | | | |
| | Lactic | ppm by | 139.0 | 139.0 | 189.9 | 120.4 | 135.5 | 139.4 | 139.4 |
| | acid (f) | mass | | | | | | | |
| | Formic | ppm by | 3.2 | 3.2 | 4.2 | 2.4 | 1.6 | 1.5 | 1.5 |
| | acid (g) | mass | | | | | | | |
| | Acetic | ppm by | 62.6 | 62.6 | 11.6 | 52.0 | 33.5 | 10.0 | 10.0 |
| | acid (h) | mass | | | | | | | |
| | Pyroglutamic | ppm by | 143.9 | 143.9 | 140.6 | 129.6 | 119.9 | 115.6 | 115.6 |
| | acid (i) | mass | | | | | | | |
| | Total content | ppm by | 1225.1 | 1225.1 | 1283.6 | 1077.7 | 966.8 | 1003.1 | 1003.1 |
| | of acids | mass | | | | | | | |
| | (a) to (i) | | | | | | | | |

| | | | | | | | | |
|---|---|---|---|---|---|---|---|---|
| Evaluation | Watery taste unsuitable | 3.0 | 3.0 | 3.0 | 3.0 | 3.0 | 3.0 | 3.0 |
| item | for beer-flavored beverage | | | | | | | |
| | Taste thickness suitable | 3.0 | 3.0 | 2.5 | 2.5 | 2.0 | 2.0 | 2.0 |
| | for beer-flavored beverage | | | | | | | |
| | Aftertaste suitable for | 2.0 | 2.5 | 2.0 | 2.5 | 2.5 | 2.0 | 2.5 |
| | beer-flavored beverage | | | | | | | |
| | Overall evaluation | B | A | B | A | B | B | B |

| | | | | Compar- | Compar- | Compar- | Compar- |
|---|---|---|---|---|---|---|---|
| | | | | ative | ative | ative | ative |
| | | | Exam- | Exam- | Exam- | Exam- | Exam- |
| | | | ple 32 | ple 13 | ple 14 | ple 15 | ple 16 |
| Alcohol by volume | | v/v % | 2.52 | 2.40 | 2.52 | 2.36 | 2.36 |
| Apparent | | % | 72.0 | 53.1 | 72.0 | 87.6 | 87.6 |
| fermentation degree | | | | | | | |
| Isomaltotriose content | | g/100 mL | 0.070 | 0.010 | 0.010 | 0.020 | 0.090 |
| pH | | — | 4.80 | 4.80 | 4.80 | 4.80 | 4.80 |
| Isomaltotriose content/ | | — | 0.097 | 0.019 | 0.014 | 0.023 | 0.103 |
| apparent fermentation | | | | | | | |
| degree × 100 | | | | | | | |
| FAN content | | mg/100 mL | 7.1 | 5.0 | 2.8 | 5.7 | 5.7 |
| Acid | Phosphoric | ppm by | 372.4 | 365.1 | 197.0 | 229.2 | 229.2 |
| component | acid (a) | mass | | | | | |
| | Citric | ppm by | 156.3 | 156.8 | 165.7 | 106.2 | 106.2 |
| | acid (b) | mass | | | | | |
| | Pyruvic | ppm by | 29.7 | 135.9 | 106.2 | 46.3 | 46.3 |
| | acid (c) | mass | | | | | |
| | Malic | ppm by | 124.7 | 213.1 | 109.1 | 78.6 | 78.6 |
| | acid (d) | mass | | | | | |
| | Succinic | ppm by | 53.4 | 57.2 | 38.2 | 32.8 | 32.8 |
| | acid (e) | mass | | | | | |
| | Lactic | ppm by | 139.4 | 156.9 | 105.9 | 60.1 | 60.1 |
| | acid (f) | mass | | | | | |
| | Formic | ppm by | 1.5 | 2.8 | 1.4 | 1.4 | 1.4 |
| | acid (g) | mass | | | | | |
| | Acetic | ppm by | 10.0 | 7.9 | 6.3 | 14.5 | 14.5 |
| | acid (h) | mass | | | | | |
| | Pyroglutamic | ppm by | 115.6 | 117.8 | 111.0 | 84.3 | 84.3 |
| | acid (i) | mass | | | | | |
| | Total content | ppm by | 1003.1 | 1213.6 | 840.8 | 653.4 | 653.4 |
| | of acids | mass | | | | | |
| | (a) to (i) | | | | | | |

| | | | | | | |
|---|---|---|---|---|---|---|
| Evaluation | Watery taste unsuitable | 3.0 | 3.0 | 3.0 | 3.0 | 3.0 |
| item | for beer-flavored beverage | | | | | |
| | Taste thickness suitable | 2.0 | 3.0 | 2.0 | 1.0 | 1.0 |
| | for beer-flavored beverage | | | | | |
| | Aftertaste suitable for | 2.5 | 1.5 | 1.5 | 2.0 | 2.5 |
| | beer-flavored beverage | | | | | |
| | Overall evaluation | B | C | C | C | C |

TABLE 5

| | | | Comparative | Comparative | Comparative |
|---|---|---|---|---|---|
| | | | Example 17 | Example 18 | Example 19 |
| Alcohol by volume | | v/v % | 2.52 | 2.43 | 2.42 |
| Apparent fermentation degree | | % | 60.1 | 60.3 | 66.2 |
| Isomaltotriose content | | g/100 mL | 0.050 | 0.070 | 0.060 |
| pH | | — | 4.23 | 4.24 | 4.23 |
| Isomaltotriose content/apparent fermentation degree × 100 | | — | 0.083 | 0.116 | 0.091 |
| FAN content | | mg/100 mL | 3.3 | 3.1 | 9.0 |
| Acid | Phosphoric acid (a) | ppm by mass | 168.5 | 177.0 | 368.7 |
| component | Citric acid (b) | ppm by mass | 163.1 | 166.4 | 141.3 |
| | Pyruvic acid (c) | ppm by mass | 75.8 | 90.9 | 11.1 |
| | Malic acid (d) | ppm by mass | 105.7 | 108.5 | 109.7 |
| | Succinic acid (e) | ppm by mass | 43.2 | 44.9 | 45.4 |
| | Lactic acid (f) | ppm by mass | 243.4 | 174.0 | 189.1 |
| | Formic acid (g) | ppm by mass | 2.0 | 3.2 | 1.6 |
| | Acetic acid (h) | ppm by mass | 12.1 | 11.9 | 33.5 |
| | Pyroglutamic acid (i) | ppm by mass | 112.6 | 113.0 | 119.9 |
| | Total content of acids (a) to (i) | ppm by mass | 926.5 | 889.8 | 1020.3 |

| | | | | |
|---|---|---|---|---|
| Evaluation | Watery taste unsuitable for beer-flavored beverage | 1.1 | 1.1 | 1.1 |
| item | Taste thickness suitable for beer-flavored beverage | 2.5 | 2.5 | 2.0 |
| | Aftertaste suitable for beer-flavored beverage | 2.5 | 3.0 | 3.0 |
| | Overall evaluation | x | x | x |

From Tables 1 to 5, it can be seen that the beer-flavored beverages prepared in Examples 1 to 32 were low-alcohol beverages, but a watery taste unsuitable for a beer-flavored beverage was suppressed, and they had an excellent balance between suitable taste thickness and aftertaste.

On the other hand, the beer-flavored beverages prepared in Comparative Examples 1 to 16 were poor in at least one of the taste thickness or the aftertaste. In addition, all of the beer-flavored beverages prepared in Comparative Examples 17 to 19 were beverages in which a watery taste unsuitable for a beer-flavored beverage was likely to be felt.

### Examples 33 to 42 and Comparative Examples 20 to 23

### <Preparation of Beverage>

Crushed barley malt was fed in a preparation tank containing 100 L of warm water kept at 40 to 55° C., then the temperature was raised to 78° C. while the temperature was repeatedly raised and kept in stages, then malt dregs were removed by filtration, and a saccharified liquid was produced. Next, hops were further added to the saccharified liquid, boiling was performed, and solid-liquid separation treatment was performed to obtain clear wort. Then, brewer's yeast was added to the pre-fermentation liquid formed by cooling the wort, and the fermentation temperature and the fermentation time were adjusted to perform alcoholic fermentation. Then, the yeast was removed by filtration to produce a beverage that would be categorized as beer in the Liquor Tax Law. The produced beverage had a real extract concentration of from 2.5 to 5.1 g/100 mL, a sugar content of from 2.5 to 4.5 g/100 mL, an ethyl acetate content of from 8 to 17 ppm by mass, a total polyphenol amount of from 80 to 150 ppm by mass, a bitterness value of from 14 to 30 BUs, and a chromaticity of from 6 to 12 EBC.

In each of Examples and Comparative Examples, the type of barley malt as an ingredient, the set temperature and the retention time in each temperature region in preparing the saccharified liquid, the presence or absence of addition of an enzyme and the timing when an enzyme is added, the fermentation temperature and the fermentation time, and the like were appropriately set, and the alcohol by volume, the apparent fermentation degree, the isomaltotriose content, the isomaltose content, and the panose content, the pH, the free amino nitrogen (FAN) content, and the content of each acid component were adjusted to values listed in Tables 6 and 7. The contents of isomaltotriose, isomaltose, and panose were adjusted to the values listed in Tables 6 and 7 by adding purified products of these substances as necessary in addition to the setting of the above-described conditions.

### <Sensory Evaluation>

Five panelists who had been regularly trained evaluated the beverages obtained in Examples and Comparative Examples cooled to approximately 4° C. for “Presence or absence of watery taste unsuitable for a beer-flavored beverage”, “Presence or absence of taste thickness suitable for a beer-flavored beverage”, and “Presence or absence of aftertaste suitable for a beer-flavored beverage” of each beverage for testing by a score in a range of 3.0 (maximum value) to 1.0 (minimum value) in increments of 0.1 based on the score criteria described above, and average values of the scores of the five panelists were calculated. The results are listed in Tables 6 and 7.

In the evaluation, samples that meet the following criteria “3.0”, “2.5”, “2.0”, “1.5”, and “1.0” were prepared in advance to standardize the criteria among the panelists. In any of the sensory evaluations in Tables 6 and 7, for the same beverage, no difference in a score value of 1.5 or more was observed among the panelists.

TABLE 6

| | | | Exam- | Exam- | Exam- | Exam- | Exam- |
|---|---|---|---|---|---|---|---|
| | | | ple 33 | ple 34 | ple 35 | ple 36 | ple 37 |
| Alcohol by volume | | v/v % | 2.40 | 2.40 | 2.52 | 2.43 | 2.42 |
| Apparent | | % | 53.1 | 53.1 | 58.5 | 59.2 | 66.2 |
| fermentation degree | | | | | | | |
| Isomaltotriose content | | g/100 mL | 0.020 | 0.090 | 0.050 | 0.070 | 0.060 |
| Isomaltose content | | g/100 mL | 0.480 | 0.480 | 0.190 | 0.380 | 0.060 |
| Total content | | g/100 mL | 0.500 | 0.570 | 0.240 | 0.450 | 0.120 |
| of isomaltotriose | | | | | | | |
| and isomaltose | | | | | | | |
| Isomaltotriose/ | | — | 0.042 | 0.188 | 0.263 | 0.184 | 1.000 |
| isomaltose content ratio | | | | | | | |
| pH | | — | 4.41 | 4.41 | 4.41 | 4.41 | 4.41 |
| Isomaltotriose content/ | | — | 0.038 | 0.169 | 0.085 | 0.118 | 0.091 |
| apparent fermentation | | | | | | | |
| degree × 100 | | | | | | | |
| FAN content | | mg/100 mL | 13.4 | 13.4 | 8.6 | 12.0 | 9.0 |
| Acid | Phosphoric | ppm by | 468.1 | 468.1 | 431.9 | 411.2 | 368.7 |
| component | acid (a) | mass | | | | | |
| | Citric | ppm by | 192.3 | 192.3 | 217.3 | 168.2 | 141.3 |
| | acid (b) | mass | | | | | |
| | Pyruvic | ppm by | 95.4 | 95.4 | 95.3 | 85.1 | 11.1 |
| | acid (c) | mass | | | | | |
| | Malic | ppm by | 96.1 | 96.1 | 141.1 | 86.0 | 109.7 |
| | acid (d) | mass | | | | | |
| | Succinic | ppm by | 24.5 | 24.5 | 51.8 | 22.8 | 45.4 |
| | acid (e) | mass | | | | | |
| | Lactic | ppm by | 175.7 | 175.7 | 226.5 | 157.0 | 172.2 |
| | acid (f) | mass | | | | | |
| | Formic | ppm by | 3.2 | 3.2 | 4.2 | 2.4 | 1.6 |
| | acid (g) | mass | | | | | |
| | Acetic | ppm by | 62.6 | 62.6 | 11.6 | 52.0 | 33.5 |
| | acid (h) | mass | | | | | |
| | Pyroglutamic | ppm by | 143.9 | 143.9 | 140.6 | 129.6 | 119.9 |
| | acid (i) | mass | | | | | |
| | Total content | ppm by | 1261.7 | 1261.7 | 1320.3 | 1114.3 | 1003.4 |
| | of acids | mass | | | | | |
| | (a) to (i) | | | | | | |
| Evaluation | Watery taste unsuitable | | 2.0 | 2.0 | 2.0 | 2.0 | 2.0 |
| item | for beer-flavored beverage | | | | | | |
| | Taste thickness suitable | | 3.0 | 3.0 | 2.5 | 2.5 | 2.0 |
| | for beer-flavored beverage | | | | | | |
| | Aftertaste suitable for | | 2.0 | 2.5 | 2.5 | 2.5 | 2.5 |
| | beer-flavored beverage | | | | | | |
| | Overall evaluation | | B | B | B | B | B |
| | | | | | | Compar- | Compar- |
| | | | | | | ative | ative |
| | | | Exam- | Exam- | Exam- | Exam- | Exam- |
| | | | ple 38 | ple 39 | ple 40 | ple 20 | ple 21 |
| Alcohol by volume | | v/v % | 2.52 | 2.52 | 2.52 | 2.40 | 2.52 |
| Apparent | | % | 72.0 | 72.0 | 72.0 | 53.1 | 72.0 |
| fermentation degree | | | | | | | |
| Isomaltotriose content | | g/100 mL | 0.020 | 0.090 | 0.070 | 0.010 | 0.010 |
| Isomaltose content | | g/100 mL | 0.020 | 0.020 | 0.020 | 0.010 | 0.010 |
| Total content | | g/100 mL | 0.040 | 0.110 | 0.090 | 0.020 | 0.020 |
| of isomaltotriose | | | | | | | |
| and isomaltose | | | | | | | |
| Isomaltotriose/ | | — | 1.000 | 4.500 | 3.500 | 1.000 | 1.000 |
| isomaltose content ratio | | | | | | | |
| pH | | — | 4.41 | 4.41 | 4.41 | 4.41 | 4.41 |
| Isomaltotriose content/ | | — | 0.028 | 0.125 | 0.097 | 0.019 | 0.014 |
| apparent fermentation | | | | | | | |
| degree × 100 | | | | | | | |
| FAN content | | mg/100 mL | 7.1 | 7.1 | 7.1 | 5.0 | 2.8 |
| Acid | Phosphoric | ppm by | 372.4 | 372.4 | 372.4 | 365.1 | 197.0 |
| component | acid (a) | mass | | | | | |
| | Citric | ppm by | 156.3 | 156.3 | 156.3 | 156.8 | 165.7 |
| | acid (b) | mass | | | | | |
| | Pyruvic | ppm by | 29.7 | 29.7 | 29.7 | 135.9 | 106.2 |
| | acid (c) | mass | | | | | |
| | Malic | ppm by | 124.7 | 124.7 | 124.7 | 213.1 | 109.1 |
| | acid (d) | mass | | | | | |
| | Succinic | ppm by | 53.4 | 53.4 | 53.4 | 57.2 | 38.2 |
| | acid (e) | mass | | | | | |
| | Lactic | ppm by | 176.0 | 176.0 | 176.0 | 203.9 | 152.9 |
| | acid (f) | mass | | | | | |
| | Formic | ppm by | 1.5 | 1.5 | 1.5 | 2.8 | 1.4 |
| | acid (g) | mass | | | | | |
| | Acetic | ppm by | 10.0 | 10.0 | 10.0 | 7.9 | 6.3 |
| | acid (h) | mass | | | | | |
| | Pyroglutamic | ppm by | 115.6 | 115.6 | 115.6 | 117.8 | 111.0 |
| | acid (i) | mass | | | | | |
| | Total content | ppm by | 1039.7 | 1039.7 | 1039.7 | 1260.6 | 887.8 |
| | of acids | mass | | | | | |
| | (a) to (i) | | | | | | |

| | | | | | | |
|---|---|---|---|---|---|---|
| Evaluation | Watery taste unsuitable | 2.0 | 2.0 | 2.0 | 2.0 | 2.0 |
| item | for beer-flavored beverage | | | | | |
| | Taste thickness suitable | 2.0 | 2.0 | 2.0 | 3.0 | 2.0 |
| | for beer-flavored beverage | | | | | |
| | Aftertaste suitable for | 2.0 | 3.0 | 2.5 | 1.5 | 1.5 |
| | beer-flavored beverage | | | | | |
| | Overall evaluation | B | B | B | C | C |

TABLE 7

| | | | | | Compar- | Compar- |
|---|---|---|---|---|---|---|
| | | | | | ative | ative |
| | | | Exam- | Exam- | Exam- | Exam- |
| | | | ple 41 | ple 42 | ple 22 | ple 23 |
| Alcohol by volume | | v/v % | 2.52 | 2.42 | 2.40 | 2.52 |
| Apparent | | % | 58.5 | 66.2 | 53.1 | 72.0 |
| fermentation degree | | | | | | |
| Isomaltotriose content | | g/100 mL | 0.050 | 0.060 | 0.010 | 0.010 |
| Isomaltose content | | g/100 mL | 0.190 | 0.060 | 0.010 | 0.010 |
| Panose content | | g/100 mL | 1.010 | 1.580 | 0.000 | 0.000 |
| Total content | | g/100 mL | 1.250 | 1.700 | 0.020 | 0.020 |
| of isomaltotriose, | | | | | | |
| isomaltose, and panose | | | | | | |
| Ratio of isomaltotriose | | — | 0.040 | 0.035 | 0.500 | 0.500 |
| content to total content | | | | | | |
| of isomaltotriose, | | | | | | |
| isomaltose, and panose | | | | | | |
| pH | | — | 4.41 | 4.41 | 4.41 | 4.41 |
| Isomaltotriose content/ | | — | 0.085 | 0.091 | 0.019 | 0.014 |
| apparent fermentation | | | | | | |
| degree × 100 | | | | | | |
| FAN content | | mg/100 mL | 8.6 | 9.0 | 5.0 | 2.8 |
| Acid | Phosphoric | ppm by | 431.9 | 368.7 | 365.1 | 197.0 |
| component | acid (a) | mass | | | | |
| | Citric | ppm by | 217.3 | 141.3 | 156.8 | 165.7 |
| | acid (b) | mass | | | | |
| | Pyruvic | ppm by | 95.3 | 11.1 | 135.9 | 106.2 |
| | acid (c) | mass | | | | |
| | Malic | ppm by | 141.1 | 109.7 | 213.1 | 109.1 |
| | acid (d) | mass | | | | |
| | Succinic | ppm by | 51.8 | 45.4 | 57.2 | 38.2 |
| | acid (e) | mass | | | | |
| | Lactic | ppm by | 226.5 | 172.2 | 203.9 | 152.9 |
| | acid (f) | mass | | | | |
| | Formic | ppm by | 4.2 | 1.6 | 2.8 | 1.4 |
| | acid (g) | mass | | | | |
| | Acetic | ppm by | 11.6 | 33.5 | 7.9 | 6.3 |
| | acid (h) | mass | | | | |
| | Pyroglutamic | ppm by | 140.6 | 119.9 | 117.8 | 111.0 |
| | acid (i) | mass | | | | |
| | Total content | ppm by | 1320.3 | 1003.4 | 1260.6 | 887.8 |
| | of acids | mass | | | | |
| | (a) to (i) | | | | | |

| | | | | | |
|---|---|---|---|---|---|
| Evaluation | Watery taste unsuitable | 2.0 | 2.0 | 2.0 | 2.0 |
| item | for beer-flavored beverage | | | | |
| | Taste thickness suitable | 2.5 | 2.0 | 3.0 | 2.0 |
| | for beer-flavored beverage | | | | |
| | Aftertaste suitable for | 2.5 | 2.5 | 1.5 | 1.5 |
| | beer-flavored beverage | | | | |
| | Overall evaluation | B | B | C | C |

From Tables 6 and 7, it can be seen that the beer-flavored beverages prepared in Examples 33 to 42 were also low-alcohol beverages, but a watery taste unsuitable for a beer-flavored beverage was suppressed, and they had an excellent balance between suitable taste thickness and aftertaste.

On the other hand, the beer-flavored beverages prepared in Comparative Examples 20 to 23 were poor in suitable aftertaste.

1. A beer-flavored beverage, comprising:
an alcohol by volume of 5.0 (v/v) % or less;
an apparent fermentation degree of 80% or less;
an isomaltotriose content of 0.020 g/100 mL or more; and
a pH of 4.30 or more.

2. The beer-flavored beverage according to claim 1, wherein a value P calculated from Formula (I) set forth below is 0.025 or more.
P=isomaltotriose content (unit: g/100 mL)/apparent fermentation degree (unit: %)×100 Formula (I):

3. The beer-flavored beverage according to claim 1, wherein a total content of acids consisting of phosphoric acid, citric acid, pyruvic acid, malic acid, succinic acid, lactic acid, formic acid, acetic acid, and pyroglutamic acid is 920 ppm by mass or more.

4. The beer-flavored beverage according to claim 1, having a pyroglutamic acid content of 100 ppm by mass or more.

5. The beer-flavored beverage according to claim 1, having a phosphoric acid content of 300 ppm by mass or more.

6. The beer-flavored beverage according to claim 1, having a free amino nitrogen (FAN) content of 6.0 mg/100 mL or more.

7. The beer-flavored beverage according to claim 1, having a real extract concentration of from 0.01 to 6.0 g/100 mL.

8. The beer-flavored beverage according to claim 1, wherein the alcohol by volume is 3.5 (v/v) % or less.

9. The beer-flavored beverage according to claim 1, wherein the alcohol by volume is 3.0 (v/v) % or less.

10. The beer-flavored beverage according to claim 1, wherein the alcohol by volume is 0.5 (v/v) % or more.

11. The beer-flavored beverage according to claim 1, having a malt proportion of 50 mass % or more and 100 mass % or less.

12. The beer-flavored beverage according to claim 1, wherein the beer-flavored beverage is beer.

13. The beer-flavored beverage according to claim 1, wherein the pH is 4.30 or more and 4.90 or less.

14. A method for producing a beer-flavored beverage having an alcohol by volume of 5.0 (v/v) % or less, an apparent fermentation degree of 80% or less, an isomaltotriose content of 0.020 g/100 mL or more, and a pH of 4.30 or more,
the method comprising steps (1) to (2) set forth below and a step (I) set forth below:
step (1): a step of producing a pre-fermentation liquid by conducting, using various ingredients, at least one treatment selected from saccharification treatment, boiling treatment, and solids content removal treatment;
step (2): a step of conducting alcoholic fermentation by adding yeast to the pre-fermentation liquid; and
step (I): a step of adjusting or confirming the isomaltotriose content.

15. A method for improving an aftertaste suitable for a beer-flavored beverage, the beer-flavored beverage having an alcohol by volume of 5.0 (v/v) % or less, the method comprising adding isomaltotriose.

16. (canceled)
